(19) United States
(12) Patent Application Publication
(10) Pub. No.: US 2026/0280100 A1
(43) Pub. Date: Sep. 17, 2026

(54) ANTENNA, COMMUNICATION DEVICE, AND COMMUNICATION SYSTEM

(71) Applicant: HUAWEI TECHNOLOGIES CO., LTD., Shenzhen (CN)

(72) Inventors: Xiang Zhang, Xi'an (CN); Chen Zhang, Xi'an (CN); Xiaofeng Li, Xi'an (CN); Jianghong Qin, Xi'an (CN)

(73) Assignee: HUAWEI TECHNOLOGIES CO., LTD., Shenzhen (CN)

(21) Appl. No.: 19/677,151

(22) Filed: May 14, 2026

Related U.S. Application Data
(63) Continuation of application No. PCT/CN2024/141602, filed on Dec. 23, 2024.

(30) Foreign Application Priority Data
Jun. 17, 2024 (CN) 202410783223.3

(51) Int. Cl. H01Q 1/22; H01Q 9/28; H01Q 15/24

(52) U.S. Cl. CPC H01Q 1/22; H01Q 9/285; H01Q 15/24

(57) ABSTRACT

An antenna includes a first polarized element, a second polarized element, and a feed network. The first polarized element includes a first radiating arm and a second radiating arm, and the second polarized element includes a third radiating arm and a fourth radiating arm. The feed network includes a first feed line circuit, a second feed line circuit, and a third feed line circuit. The first feed line circuit is feed-connected to the first polarized element, and the second feed line circuit is feed-connected to the second polarized element. The third feed line circuit is feed-connected to the first radiating arm and the third radiating arm.

### CROSS-REFERENCE TO RELATED APPLICATIONS

This application is a continuation of International Application No. PCT/CN 2024/141602, filed on Dec. 23, 2024, which claims priority to Chinese Patent Application No. 202410783223.3, filed on Jun. 17, 2024. The disclosures of the aforementioned applications are hereby incorporated by reference in their entireties.

### TECHNICAL FIELD

This disclosure relates to the field of communication technologies, and in particular, to an antenna, a communication device, and a communication system.

### BACKGROUND

In some communication devices, antennas are typically used for radio signal transmission and reception. An antenna typically includes an element and a feed network. The element is configured to radiate electromagnetic waves to or receive electromagnetic waves from external environment. The feed network is feed-connected to the element, and is configured to perform processing such as frequency selection and amplification on the electromagnetic waves received by the element. Alternatively, the feed network is configured to send feed signals to the element, so that the element radiates electromagnetic waves to the external environment, to implement the radio signal transmission and reception. In common directional antennas, coverage of the electromagnetic waves radiated by the element is relatively narrow, and large coverage blind areas exist outside a main lobe.

### SUMMARY

This disclosure provides an antenna, a communication device, and a communication system with a large signal coverage.

According to a first aspect, this disclosure provides an antenna, including a first polarized element, a second polarized element, and a feed network. The first polarized element and the second polarized element are orthogonally disposed. The first polarized element includes a first radiating arm and a second radiating arm, and the second polarized element includes a third radiating arm and a fourth radiating arm. The feed network includes a first feed line circuit, a second feed line circuit, and a third feed line circuit. The first feed line circuit is feed-connected to the first radiating arm and the second radiating arm, and the second feed line circuit is feed-connected to the third radiating arm and the fourth radiating arm. The third feed line circuit is feed-connected to the first radiating arm and the third radiating arm. Alternatively, the third feed line circuit is feed-connected to the first radiating arm and the fourth radiating arm. Alternatively, the third feed line circuit is feed-connected to the second radiating arm and the third radiating arm. Alternatively, the third feed line circuit is feed-connected to the second radiating arm and the fourth radiating arm. That is, one radiating arm of the first polarized element and one radiating arm of the second polarized element may form the third polarized element.

In summary, the antenna is a dual-polarized antenna, and the antenna may radiate two types of electromagnetic waves with different polarizations to the outside by using the first polarized element and the second polarized element, to ensure signal transceiver performance of the antenna. In addition, in the antenna provided in this disclosure, reuse of the first polarized element and the second polarized element can further implement effective signal coverage in an X-axis direction and a Y-axis direction, which compensates for a signal coverage blind area of the antenna. For example, when the third feed line circuit is feed-connected to the first radiating arm and the third radiating arm, the first radiating arm and the third radiating arm can send an electromagnetic wave to the outside. In addition, when the first radiating arm and the third radiating arm are fed, a coupling current is further generated in the second radiating arm and the fourth radiating arm, which causes a radiation pattern of the antenna to deflect toward a lateral direction (vertical to a Z-axis direction). In this way, lateral radiation is formed. That is, effective signal coverage can be implemented in the X-axis direction and the Y-axis direction, which reduces the signal coverage blind area of the antenna.

In some embodiments, the first radiating arm, the second radiating arm, the third radiating arm, and the fourth radiating arm may all be located on a same plane, so that a maximum radiation direction of an electromagnetic wave radiated by the first polarized element and the second polarized element of the antenna is perpendicular to the plane, and good radiation gains are obtained. The first radiating arm is adjacent to the third radiating arm and the fourth radiating arm, and the second radiating arm is adjacent to the third radiating arm and the fourth radiating arm. Therefore, when the third feed line circuit feeds the third polarized element, a lateral radiation range of the antenna can be effectively improved.

In an example, the first feed line circuit includes a first feed line and a first ground line. The first ground line is feed-connected to the first radiating arm, and the first feed line is feed-connected to the second radiating arm. The second feed line circuit includes a second feed line and a second ground line. The second ground line is feed-connected to the third radiating arm, and the second feed line is feed-connected to the fourth radiating arm.

In an example, when the third feed line circuit is coupled to the first radiating arm and the third radiating arm, the third feed line circuit may include the first ground line and the second ground line. In other words, the third feed line circuit can effectively reuse the first feed line circuit and the second feed line circuit, which can effectively simplify and properly use a feeding structure.

In an example, the third feed line circuit further includes a first coupling piece. One end of the first coupling piece is located on a side of the second ground line, which facilitates a connection of an external feed line circuit to both the second ground line and the first coupling piece. The other end of the first coupling piece is coupled to the first ground line. The first coupling piece can effectively improve connection effect between the third feed line circuit and a radio frequency processing chip or another feed line circuit.

In an example, when the third feed line circuit is coupled to the second radiating arm and the third radiating arm, the third feed line circuit may include the second ground line and a second coupling piece. One end of the second coupling piece is located on a side of the second ground line, which facilitates a connection of the external feed line circuit to both the second ground line and the second coupling piece. The other end of the second coupling piece is coupled to the second radiating arm.

In some embodiments, the antenna further includes a first dielectric substrate, and the first radiating arm, the second radiating arm, the third radiating arm, and the fourth radiating arm are all located on a same substrate surface of the first dielectric substrate. That is, an element in the antenna may be in a structure form of a printed circuit board, offering good manufacturing convenience and reliability.

In an example, the antenna further includes a second dielectric substrate. The second dielectric substrate is located on a side of the first dielectric substrate, and the first dielectric substrate and the second dielectric substrate are perpendicular to each other. Portions of the feed line circuits are located on the second dielectric substrate, and the other portions of the feed line circuits are located on the first dielectric substrate. The second dielectric substrate may provide an effective disposition position for the feed line circuit, and ensure structural stability between the feed line circuit and the element.

In an example, the antenna further includes a reflector plate. The reflector plate and the first dielectric substrate are disposed opposite to each other, and the second dielectric substrate is connected between the first dielectric substrate and the reflector plate. Radiation gains of the antenna can be optimized by using the reflector plate, which ensures performance of the antenna.

In an example, the first radiating arm, the second radiating arm, the third radiating arm, and the fourth radiating arm may all be in a step shape. Deposition of a structure in the step shape helps improve isolation between different polarizations, which can ensure performance of the antenna.

In an example, the antenna may include a plurality of main elements. Each main element includes the first polarized element and the second polarized element. Disposing the plurality of main elements can effectively improve gains of the antenna, and further help improve a radiation range of the antenna.

According to a second aspect, this disclosure further provides a communication device, including a radio frequency processing unit and the antenna in the first aspect. The radio frequency processing unit is connected to the feed network. The radio frequency processing unit may be configured to perform frequency selection, amplification, and down-conversion processing on a signal received by an element in the antenna. Alternatively, the radio frequency processing unit may be configured to send a radio frequency signal to the antenna, to implement functions such as signal transceiver of the antenna. By applying the foregoing antenna, an integration level of the communication device can be effectively improved, and a quantity of used parts can be effectively reduced. In addition, this helps ensure signal transceiver performance of the communication device.

In an example, the communication device may further include a baseband processing unit. The baseband processing unit is connected to the radio frequency processing unit. For example, the radio frequency processing unit may be configured to: perform frequency selection, amplification, and down-conversion processing on a signal received by the antenna, convert the signal into an intermediate frequency signal or a baseband signal, and send the intermediate frequency signal or the baseband signal to the baseband processing unit. Alternatively, the radio frequency processing unit is configured to: perform up-conversion and amplification processing on an intermediate frequency signal sent by the baseband processing unit, convert the intermediate frequency signal into a radio signal through the antenna, and send the radio signal.

According to a third aspect, this disclosure further provides a communication system, including at least one communication device in the second aspect. The communication device may be a network device or a terminal device. In the communication system provided in this disclosure, the foregoing communication device is equipped, so that signal transceiver performance of the communication system can be effectively improved and good adaptation flexibility can be achieved.

### BRIEF DESCRIPTION OF DRAWINGS

FIG. 1 is a diagram of an application scenario of an antenna according to an embodiment of this disclosure;

FIG. 2 is a block diagram of a structure of consumer premises equipment (CPE) according to an embodiment of this disclosure;

FIG. 3 is a diagram of a conventional planar structure of antenna elements according to an embodiment of this disclosure;

FIG. 4 is a diagram of a three-dimensional structure of an antenna according to an embodiment of this disclosure;

FIG. 5 is a block diagram of a structure of an antenna according to an embodiment of this disclosure;

FIG. 6 is a diagram of a radiation pattern of an antenna according to an embodiment of this disclosure;

FIG. 7 is a diagram of another radiation pattern of an antenna according to an embodiment of this disclosure;

FIG. 8 is a diagram of another radiation pattern of an antenna according to an embodiment of this disclosure;

FIG. 9 is a diagram of another radiation pattern of an antenna according to an embodiment of this disclosure;

FIG. 10 is a diagram of another radiation pattern of an antenna according to an embodiment of this disclosure;

FIG. 11 is a diagram of another radiation pattern of an antenna according to an embodiment of this disclosure;

FIG. 12 is an S-parameter diagram of an antenna according to an embodiment of this disclosure;

FIG. 13 is a current distribution diagram of an antenna according to an embodiment of this disclosure;

FIG. 14 is another current distribution diagram of an antenna according to an embodiment of this disclosure;

FIG. 15 is another current distribution diagram of an antenna according to an embodiment of this disclosure;

FIG. 16 is another current distribution diagram of an antenna according to an embodiment of this disclosure;

FIG. 17 is another S-parameter diagram of an antenna according to an embodiment of this disclosure;

FIG. 18 is another current distribution diagram of an antenna according to an embodiment of this disclosure;

FIG. 19 is another current distribution diagram of an antenna according to an embodiment of this disclosure;

FIG. 20 is another S-parameter diagram of an antenna according to an embodiment of this disclosure;

FIG. 21 is an efficiency simulation diagram of an antenna according to an embodiment of this disclosure;

FIG. 22 is a diagram of another three-dimensional structure of an antenna according to an embodiment of this disclosure;

FIG. 23 is a diagram of another three-dimensional structure of an antenna according to an embodiment of this disclosure;

FIG. 24 is a diagram of a planar structure of antenna elements according to an embodiment of this disclosure;

FIG. 25 is a diagram of another planar structure of antenna elements according to an embodiment of this disclosure;

FIG. 26 is a diagram of another planar structure of antenna elements according to an embodiment of this disclosure;

FIG. 27 is a diagram of another planar structure of antenna elements according to an embodiment of this disclosure;

FIG. 28 is a diagram of another planar structure of antenna elements according to an embodiment of this disclosure;

FIG. 29 is another S-parameter diagram of an antenna according to an embodiment of this disclosure;

FIG. 30 is another S-parameter diagram of an antenna according to an embodiment of this disclosure;

FIG. 31 is another S-parameter diagram of an antenna according to an embodiment of this disclosure;

FIG. 32 is another S-parameter diagram of an antenna according to an embodiment of this disclosure;

FIG. 33 is a diagram of another planar structure of antenna elements according to an embodiment of this disclosure;

FIG. 34 is a diagram of another planar structure of antenna elements according to an embodiment of this disclosure;

FIG. 35 is a diagram of another planar structure of antenna elements according to an embodiment of this disclosure;

FIG. 36 is another S-parameter diagram of an antenna according to an embodiment of this disclosure;

FIG. 37 is another S-parameter diagram of an antenna according to an embodiment of this disclosure;

FIG. 38 is another S-parameter diagram of an antenna according to an embodiment of this disclosure;

FIG. 39 is a diagram of another radiation pattern of an antenna according to an embodiment of this disclosure;

FIG. 40 is a diagram of another radiation pattern of an antenna according to an embodiment of this disclosure;

FIG. 41 is another S-parameter diagram of an antenna according to an embodiment of this disclosure;

FIG. 42 is another efficiency simulation diagram of an antenna according to an embodiment of this disclosure;

FIG. 43 is another S-parameter diagram of an antenna according to an embodiment of this disclosure;

FIG. 44 is a diagram of another planar structure of antenna elements according to an embodiment of this disclosure;

FIG. 45 is a diagram of another radiation pattern of an antenna according to an embodiment of this disclosure;

FIG. 46 is a diagram of another radiation pattern of an antenna according to an embodiment of this disclosure;

FIG. 47 is a diagram of another radiation pattern of an antenna according to an embodiment of this disclosure;

FIG. 48 is a diagram of another radiation pattern of an antenna according to an embodiment of this disclosure;

FIG. 49 is a diagram of another radiation pattern of an antenna according to an embodiment of this disclosure;

FIG. 50 is a diagram of another radiation pattern of an antenna according to an embodiment of this disclosure;

FIG. 51 is a diagram of another radiation pattern of an antenna according to an embodiment of this disclosure;

FIG. 52 is a diagram of another radiation pattern of an antenna according to an embodiment of this disclosure;

FIG. 53 is another S-parameter diagram of an antenna according to an embodiment of this disclosure;

FIG. 54 is another efficiency simulation diagram of an antenna according to an embodiment of this disclosure;

FIG. 55 is a diagram of another three-dimensional structure of an antenna according to an embodiment of this disclosure;

FIG. 56 is a diagram of another three-dimensional structure of an antenna according to an embodiment of this disclosure;

FIG. 57 is a diagram of a structure of a side surface of an antenna according to an embodiment of this disclosure;

FIG. 58 is a diagram of another structure of a side surface of an antenna according to an embodiment of this disclosure;

FIG. 59 is a diagram of another structure of a side surface of an antenna according to an embodiment of this disclosure;

FIG. 60 is a diagram of a planar structure of an antenna according to an embodiment of this disclosure;

FIG. 61 is diagram of another structure of a side surface of an antenna according to an embodiment of this disclosure;

FIG. 62 is a diagram of another structure of a side surface of an antenna according to an embodiment of this disclosure;

FIG. 63 is a diagram of another three-dimensional structure of an antenna according to an embodiment of this disclosure; and

FIG. 64 is a block diagram of a structure of a communication system according to an embodiment of this disclosure.

### DESCRIPTION OF EMBODIMENTS

Antennas provided in embodiments of this disclosure may be used in communication devices such as CPEs, base stations, routers, or radars, to implement a wireless communication function. In other words, the antennas provided in this disclosure may be used in terminal devices or network devices, for example, base stations or access points. This is not limited in this disclosure.

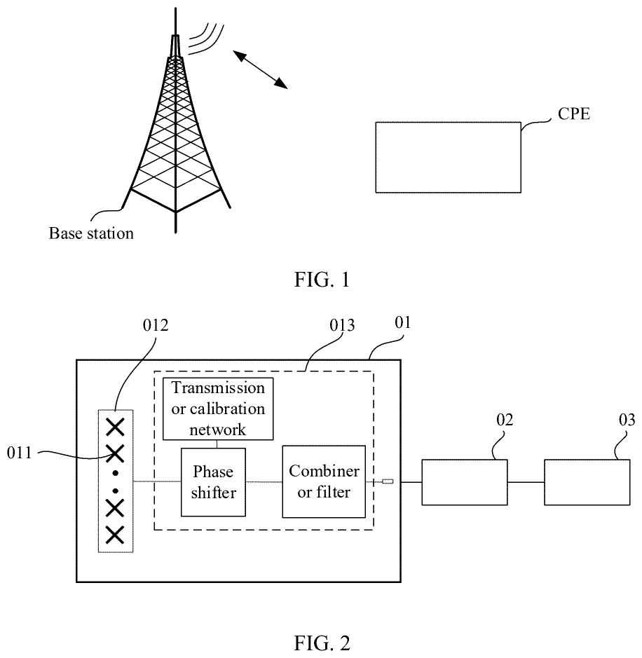

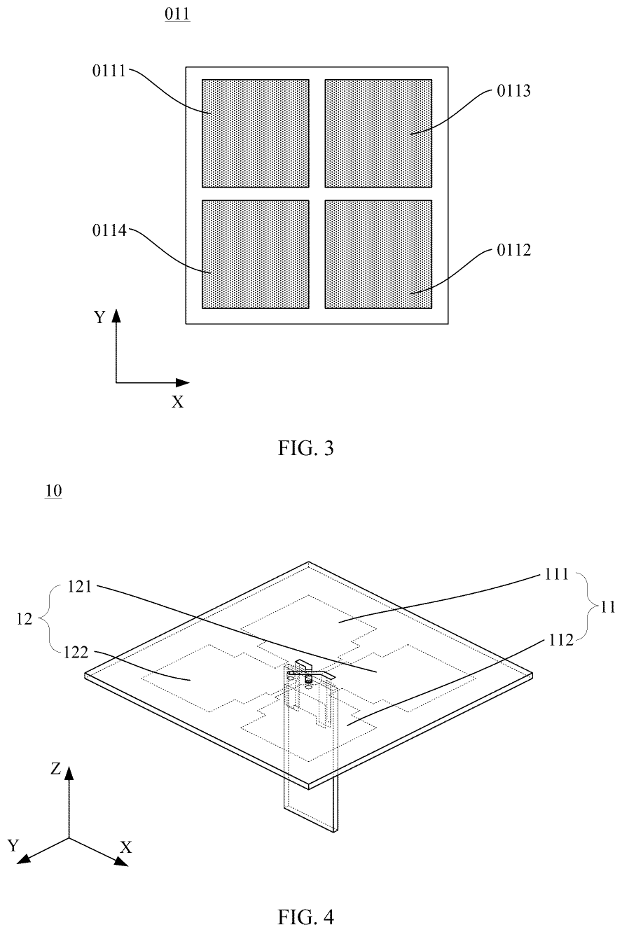

As shown in FIG. 1, the application scenario may include a base station and a CPE. Wireless communication may be implemented between the base station and the CPE. As shown in FIG. 2, for example, the antenna provided in this disclosure is used in the CPE. The CPE may include an antenna 01, a radio frequency processing unit 02, and a baseband processing unit 03. For example, the radio frequency processing unit 02 may be configured to: perform frequency selection, amplification, and down-conversion processing on a signal received by the antenna 01, convert the signal into an intermediate frequency signal or a baseband signal, and send the intermediate frequency signal or the baseband signal to the baseband processing unit 03. Alternatively, the radio frequency processing unit 02 is configured to: perform up-conversion and amplification processing on an intermediate frequency signal sent by the baseband processing unit 03, convert the intermediate frequency signal into a radio signal through the antenna 01, and send the radio signal. The baseband processing unit 03 may be connected to a feed network 013 of the antenna 01 through the radio frequency processing unit 02. In some embodiments, the radio frequency processing unit 02 may also be referred to as a remote radio unit (RRU), and the baseband processing unit 03 may also be referred to as a baseband unit (BBU).

In a possible embodiment, the radio frequency processing unit 02 may be integrated with the antenna 01, the baseband processing unit 03 is located at a remote end of the antenna 01, and the radio frequency processing unit 02 may be connected to the baseband processing unit 03 through a feed line. In another embodiment, both the radio frequency processing unit 02 and the baseband processing unit 03 may alternatively be located at the remote end of the antenna 01.

As shown in FIG. 2, the antenna 01 may include a plurality of elements 011, a reflector plate 012, and a feed network 013. The reflector plate 012 may also be referred to as a bottom plate. A main function of the feed network 013 is to feed a signal to the element 011 based on an amplitude and phase, or send a radio signal received by the element 011 to the baseband processing unit 03 based on an amplitude and phase. The feed network 013 may include at least one of devices: a phase shifter, a combiner, a transmission or calibration network, a filter, or the like. Components and types of the feed network 013 and functions that can be implemented by the feed network 013 are not limited in this disclosure.

In addition, as shown in FIG. 3, an antenna with dual-polarized elements is shown. The element 011 includes a radiating arm 0111, a radiating arm 0112, a radiating arm 0113, and a radiating arm 0114. The radiating arm 0111 and the radiating arm 0112 jointly form one polarized element. The radiating arm 0113 and the radiating arm 0114 jointly form the other polarized element. The radiating arm 0111, the radiating arm 0112, the radiating arm 0113, and the radiating arm 0114 are all located on a substantially same plane. The plane is parallel to both an X-axis and a Y-axis, so that maximum radiation of the element 011 is consistent with a Z-axis (not shown in FIG. 3). The Z-axis is perpendicular to both the X-axis and the Y-axis. That is, a beam direction of the element 011 is consistent with the Z-axis, while there are signal coverage blind areas in lateral directions (for example, an X-axis direction and a Y-axis direction). Therefore, when the base station is in the signal coverage blind area, reliable communication cannot be implemented between the base station and a communication device (for example, the CPE).

Therefore, this disclosure provides an antenna that can implement effective signal coverage in the lateral direction.

As shown in FIG. 4, in an example provided in this disclosure, an antenna 10 includes elements and a feed network (not shown in the figure). The elements include a first polarized element 11 and a second polarized element 12. The first polarized element 11 and the second polarized element 12 are orthogonally disposed. The first polarized element 11 includes a first radiating arm 111 and a second radiating arm 112, and the second polarized element 12 includes a third radiating arm 121 and a fourth radiating arm 122. That is, the first radiating arm 111 and the second radiating arm 112 form the first polarized element 11, and the third radiating arm 121 and the fourth radiating arm 122 form the second polarized element 12.

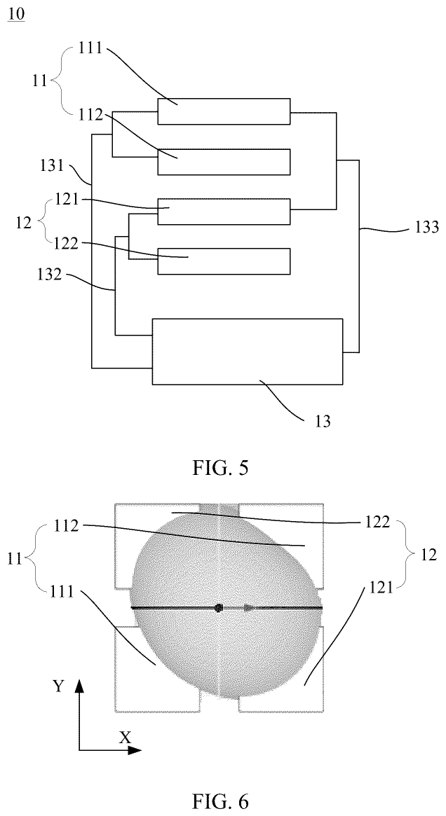

As shown in FIG. 5, the feed network 13 includes a first feed line circuit 131 and a second feed line circuit 132. The first feed line circuit 131 is feed-connected to the first radiating arm 111 and the second radiating arm 112, so that the first radiating arm 111 and the second radiating arm 112 can send an electromagnetic wave to the outside. The second feed line circuit 132 is feed-connected to the third radiating arm 121 and the fourth radiating arm 122, so that the third radiating arm 121 and the fourth radiating arm 122 can send an electromagnetic wave to the outside.

In summary, the antenna 10 is a dual-polarized antenna, and the antenna 10 may radiate two types of electromagnetic waves with different polarizations to the outside by using the first polarized element 11 and the second polarized element 12, to ensure signal transceiver performance of the antenna 10. During practical application, based on different spatial orientations of the antenna 10, the electromagnetic wave radiated by the first polarized element 11 may be a horizontally polarized electromagnetic wave, or may be a vertically polarized electromagnetic wave. Correspondingly, the electromagnetic wave radiated by the second polarized element 12 may be a vertically polarized electromagnetic wave, or may be a horizontally polarized electromagnetic wave. A radio frequency processing unit (not shown in FIG. 5) may be connected to the first polarized element 11 through the first feed line circuit 131, to send a feed signal to the first polarized element 11 through the first feed line circuit 131. In this way, the first polarized element 11 radiates the electromagnetic wave to the outside. Correspondingly, the radio frequency processing unit may be connected to the second polarized element 12 through the second feed line circuit 132, to send a feed signal to the second polarized element 12 through the second feed line circuit 132. In this way, the second polarized element 12 radiates the electromagnetic wave to the outside. That is, the antenna 10 has good radiation gains in a Z-axis direction by using the first polarized element 11 and the second polarized element 12.

In addition, in an example provided in this application, reuse of the first polarized element 11 and the second polarized element 12 can further implement effective signal coverage in an X-axis direction and a Y-axis direction, which reduces a signal coverage blind area of the antenna 10.

Specifically, as shown in FIG. 5, the feed network 13 further includes a third feed line circuit 133. In the example provided in FIG. 5, the third feed line circuit 133 is feed-connected to the first radiating arm 111 and the third radiating arm 121, so that the first radiating arm 111 and the third radiating arm 121 can send an electromagnetic wave to the outside. When the first radiating arm 111 and the third radiating arm 121 are fed, a coupling current is further generated in the second radiating arm 112 and the fourth radiating arm 122, which causes a radiation pattern of the antenna 10 to deflect toward a lateral direction (vertical to the Z-axis direction). In this way, lateral radiation is formed. That is, a radiation direction of the antenna 10 is deflected from the Z-axis to a plane on which the X-axis and the Y-axis are located, so that effective signal coverage in the X-axis direction and the Y-axis direction is implemented, which reduces the signal coverage blind area of the antenna 10.

It should be noted that for ease of understanding the technical solutions of this application, in the following example, an element formed by the first radiating arm 111 and the third radiating arm 121 is referred to as a third polarized element.

As shown in FIG. 6 to FIG. 11, an embodiment of this application further provides radiation patterns of the antenna 10 in two different modes. In a first mode, an operating frequency band of the antenna 10 is around 3.1 GHz. In the second mode, the operating frequency band of the antenna 10 is around 4.63 GHz. Alternatively, it may be understood that the antenna 10 has two resonance frequencies. The first mode means a low resonance frequency of the antenna 10, and the second mode means a high resonance frequency of the antenna 10.

It should be noted that parameters such as sizes and shapes of the first radiating arm 111, the second radiating arm 112, the third radiating arm 121, and the fourth radiating arm 122 have obvious impact on the resonance frequency of the entire antenna 10. Therefore, during actual application, the parameters such as shapes and sizes of the first radiating arm 111, the second radiating arm 112, the third radiating arm 121, and the fourth radiating arm 122 may be properly set based on an actual requirement.

In addition, during actual application, the antenna 10 may also have one resonance frequency, or the antenna 10 may also have three or more resonance frequencies.

For ease of understanding the technical solutions of this application, in the following examples, an example in which the antenna 10 has two resonance frequencies is used for description.

As shown in FIG. 6, when the antenna 10 operates at around 3.1 GHz, a radiation direction of the first polarized element 11 is consistent with the Z-axis (not shown in FIG. 6). The Z-axis is perpendicular to both the X-axis and the Y-axis.

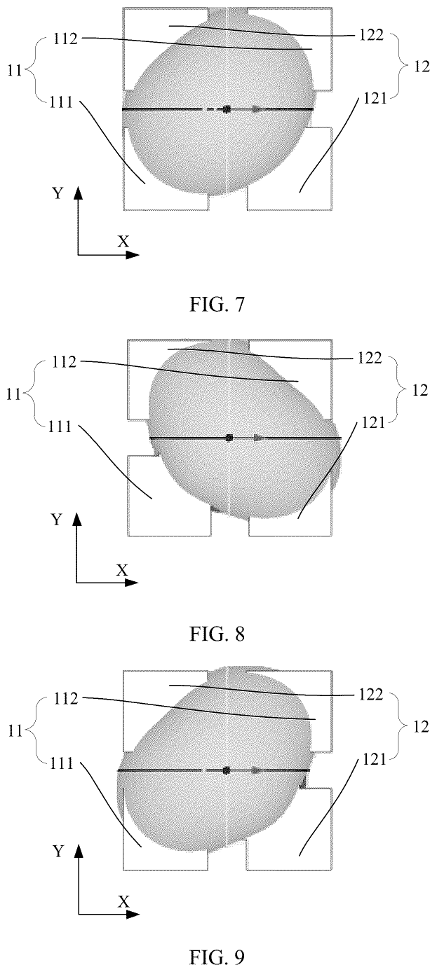

As shown in FIG. 7, when the antenna 10 operates at around 3.1 GHz, a radiation direction of the second polarized element 12 is consistent with the Z-axis (not shown in FIG. 7).

As shown in FIG. 8, when the antenna 10 operates at around 4.63 GHz, the radiation direction of the first polarized element 11 is consistent with the Z-axis (not shown in FIG. 8). The Z-axis is perpendicular to both the X-axis and the Y-axis.

As shown in FIG. 9, when the antenna 10 operates at around 4.63 GHz, the radiation direction of the second polarized element 12 is consistent with the Z-axis (not shown in FIG. 9).

In addition, with reference to FIG. 6 to FIG. 9, it can be obviously learned that the radiation direction of the antenna 10 is consistent with the Z-axis in both of the two modes, and there are no obvious gains in the X-axis direction and the Y-axis direction. As a result, coverage blind areas exist in the X-axis direction and the Y-axis direction of the antenna 10.

After the third feed line circuit 133 is feed-connected to the first radiating arm 111 and the third radiating arm 121, effective signal coverage may be implemented in the X-axis direction and the Y-axis direction, which reduces the signal coverage blind area of the antenna 10.

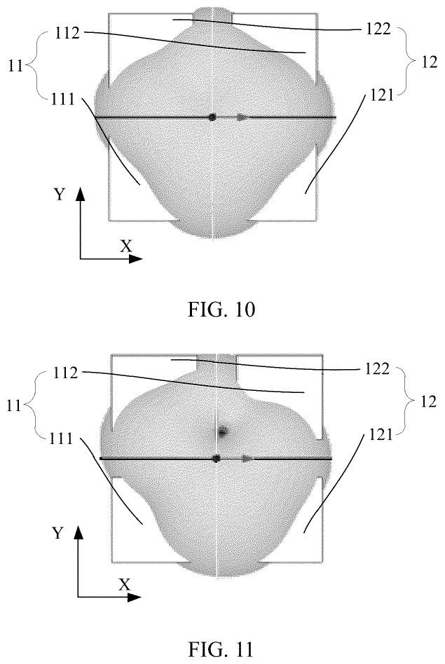

For example, as shown in FIG. 10, when the antenna 10 operates at around 3.55 GHz, the third polarized element has obvious radiation gains in both the X-axis direction and the Y-axis direction. Therefore, lateral radiation of the antenna 10 can be implemented, and the signal coverage blind area of the antenna 10 can be effectively reduced.

As shown in FIG. 11, when the antenna 10 operates at around 4.7 GHz, the third polarized element has obvious radiation gains in both the X-axis direction and the Y-axis direction. Therefore, lateral radiation of the antenna 10 can be implemented, and the signal coverage blind area of the antenna 10 can be effectively reduced.

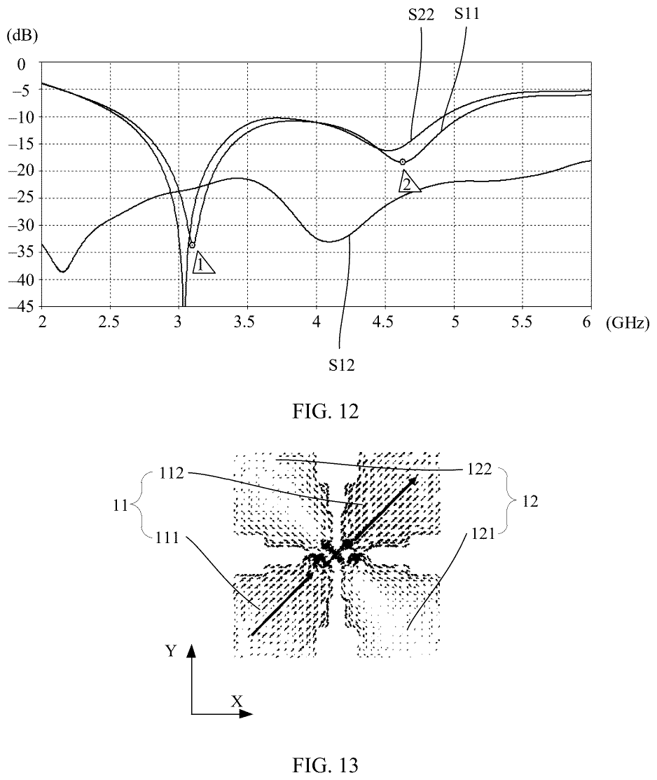

In addition, as shown in FIG. 12, in an example provided in this application, S parameters of the antenna 10 are further provided when the first polarized element 11 and the second polarized element 12 are fed. In FIG. 12, a horizontal coordinate represents a frequency in a unit of GHz, and a vertical coordinate represents a return loss in a unit of dB. S11 represents a curve of a return loss that is of the first polarized element 11 and that changes with the frequency. S22 represents a curve of a return loss that is of the second polarized element 12 and that changes with the frequency. S12 represents isolation between the first polarized element 11 and the second polarized element 12.

It can be learned from FIG. 12 that the antenna 10 has two resonance frequencies: 3.1 GHz and 4.63 GHz, and may cover a frequency band from 3.3 GHz to 5 GHz. That is, the antenna 10 may completely cover frequency bands such as N77, N78, and N79. In addition, because the first polarized element 11 and the second polarized element 12 are orthogonal, the antenna 10 can obtain isolation of greater than 20 dB, and has good signal transceiver performance.

It should be noted that the two resonance frequencies 3.1 GHz and 4.63 GHz mean approximate resonance frequencies, and during actual application, a deviation may exist to some extent.

In addition, FIG. 13 to FIG. 16 further show current distribution diagrams of the antenna 10.

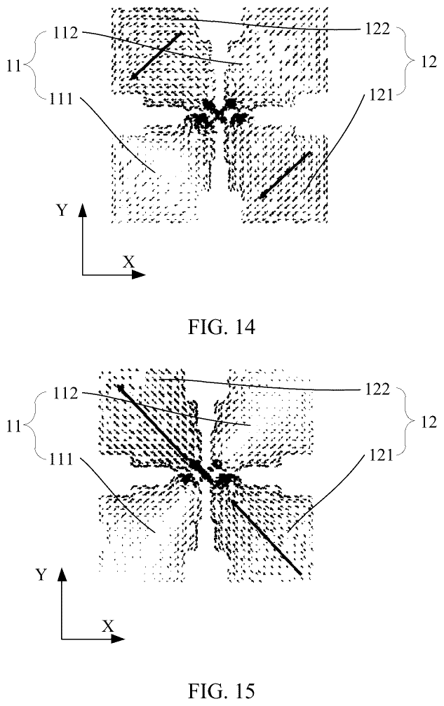

FIG. 13 and FIG. 14 show current distribution of the antenna 10 when the first polarized element 11 is fed.

FIG. 13 shows current distribution of an active dipole (dipole) element in a half-wavelength mode. In this case, the resonance frequency of the antenna 10 is around 3.1 GHz. FIG. 14 shows current distribution when the first polarized element 11 is coupled to a coupled passive dipole (dipole) element of the second polarized element 12 in the half-wavelength mode. In this case, the resonance frequency of the antenna 10 is around 4.63 GHz. Solid line arrows are used in FIG. 13 and FIG. 14 to clearly show general current flowing directions.

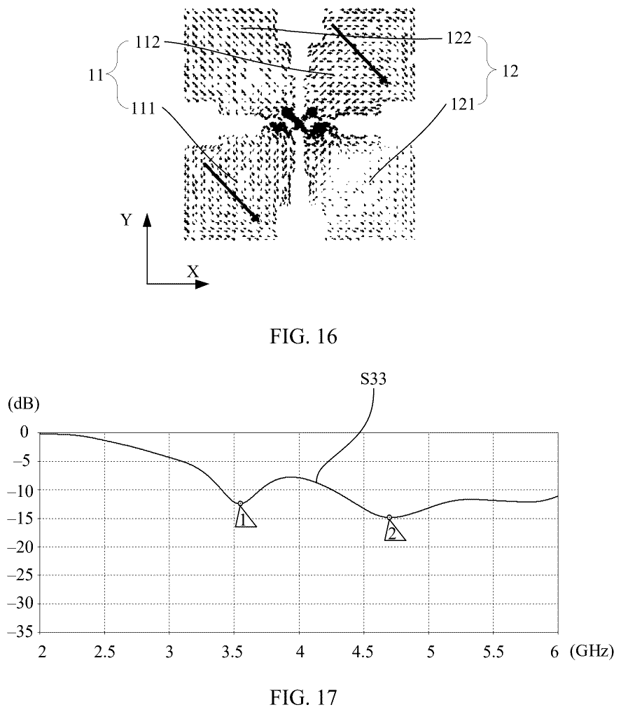

FIG. 15 and FIG. 16 show current distribution of the antenna 10 when the second polarized element 12 is fed.

FIG. 15 shows current distribution of an active dipole (dipole) element in a half-wavelength mode. In this case, the resonance frequency of the antenna 10 is around 3.1 GHz. FIG. 16 shows current distribution when the second polarized element 12 is coupled to a coupled passive dipole (dipole) element of the first polarized element 11 in the half-wavelength mode. In this case, the resonance frequency of the antenna 10 is around 4.63 GHz. Solid line arrows are used in FIG. 15 and FIG. 16 to clearly show general current flowing directions.

With reference to FIG. 13 to FIG. 16, it can be obviously learned that in terms of current distribution, when the first polarized element 11 and the second polarized element 12 are fed, current flowing directions (or current modes) are orthogonal. This achieves good isolation between the first polarized element 11 and the second polarized element 12, and can ensure signal transceiver performance of the antenna 10.

In addition, as shown in FIG. 17, in an example provided in this application, S parameters of the antenna 10 are further provided when the third polarized element (the first radiating arm 111 and the third radiating arm 121) is fed, that is, the S-parameters of the antenna 10 when the radio frequency processing unit feeds the first radiating arm 111 and the third radiating arm 121 through the third feed line circuit 133. In FIG. 17, a horizontal coordinate represents a frequency in a unit of GHz, and a vertical coordinate represents a return loss in a unit of dB. S33 represents a curve of a return loss that is of the third polarized element and that changes with the frequency.

It can be learned from FIG. 17 that the antenna 10 has two resonances: 3.55 GHz and 4.7 GHz, and may cover a frequency band from 3.3 GHz to 5 GHz. That is, the antenna 10 may completely cover frequency bands such as N77, N78, and N79.

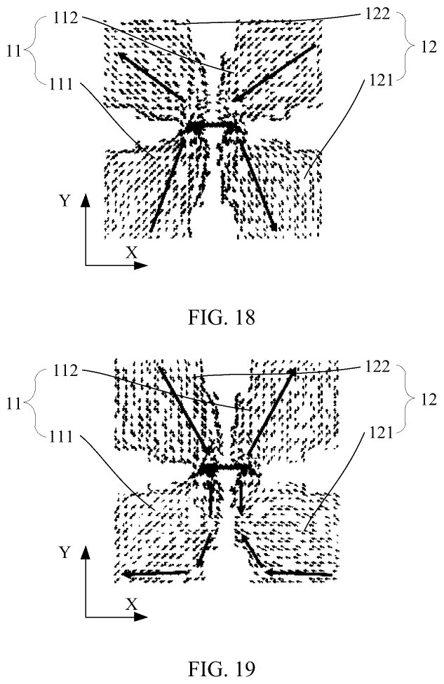

FIG. 18 and FIG. 19 further show current distribution diagrams of the antenna 10 when the third polarized element is fed. Solid line arrows are used in FIG. 18 and FIG. 19 to show a current.

FIG. 18 shows current distribution of a dipole in a half-wavelength mode. In this case, the resonance frequency of the antenna 10 is around 3.55 GHz. FIG. 19 shows current distribution of a dipole (dipole) in a three-half wavelength mode. In this case, the resonance frequency of the antenna 10 is around 4.7 GHz. In this case, a reverse current generated by coupling the first radiating arm 111 and the third radiating arm 121 to the second radiating arm 112 and the fourth radiating arm 122 causes a radiation pattern of the antenna 10 to deflect toward a lateral direction (in the X-axis direction or the Y-axis direction). In this way, lateral radiation is formed. With reference to FIG. 13 to FIG. 16, it can be obviously learned that the current distribution in FIG. 18 and FIG. 19 and FIG. 13 to FIG. 16 is orthogonal. This achieves good isolation among three ports of the antenna 10, which can ensure signal transceiver performance of the antenna 10.

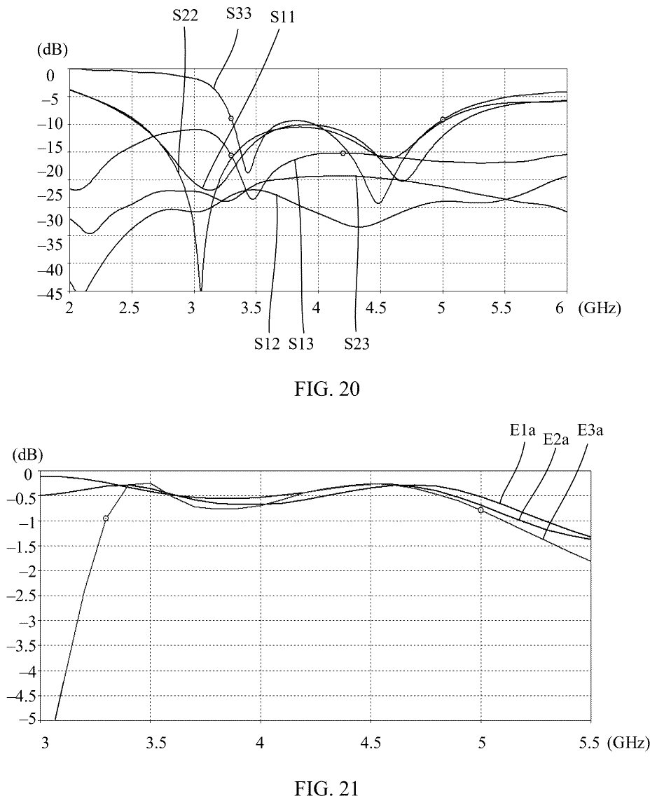

In addition, as shown in FIG. 20, in an example provided in this application, S parameters of the antenna 10 are further provided when the first polarized element 11, the second polarized element 12, and the third polarized element are fed. In FIG. 20, a horizontal coordinate represents a frequency in a unit of GHz, and a vertical coordinate represents a return loss in a unit of dB. S11 represents a curve of a return loss that is of the first polarized element 11 and that changes with the frequency. S22 represents a curve of a return loss that is of the second polarized element 12 and that changes with the frequency. S33 represents a curve of a return loss that is of the third polarized element and that changes with the frequency. S12 represents isolation between the first polarized element 11 and the second polarized element 12. S13 represents isolation between the first polarized element 11 and the third polarized element. S23 represents isolation between the second polarized element 12 and the third polarized element.

It can be learned from FIG. 20 that the antenna 10 has two resonances: around 3.1 GHz and around 4.63 GHz, and may cover a frequency band from 3.3 GHz to 5 GHz. That is, the antenna 10 may completely cover frequency bands such as N77, N78, and N79. In addition, isolation between the first polarized element 11 and the second polarized element 12 is greater than 22 dB, isolation between the first polarized element 11 and the third polarized element is greater than 15 dB, and isolation between the second polarized element 12 and the third polarized element is greater than 18 dB. That is, good isolation is achieved among the first polarized element 11, the second polarized element 12, and the third polarized element, which can ensure signal transceiver performance of the antenna 10.

In addition, FIG. 21 further shows an efficiency simulation diagram of the antenna 10. In FIG. 21, a horizontal coordinate represents a frequency in a unit of GHz, and a vertical coordinate represents efficiency in a unit of dB. In FIG. 21, E1a represents efficiency of the first polarized element 11, E2a represents efficiency of the second polarized element 12, and E3a represents efficiency of the third polarized element.

In summary, it can be learned from FIG. 21 that overall efficiency of the antenna 10 can meet an actual application requirement.

In some embodiments, structure types of the first radiating arm 111, the second radiating arm 112, the third radiating arm 121, and the fourth radiating arm 122 may be diverse.

For example, the first radiating arm 111, the second radiating arm 112, the third radiating arm 121, and the fourth radiating arm 122 may be metal sheet metal parts, or may be metal layers located on a dielectric substrate, or the like. The first radiating arm 111, the second radiating arm 112, the third radiating arm 121, and the fourth radiating arm 122 may be properly selected based on currently commonly used types. This is not limited in this disclosure.

In the following examples, an example in which the first radiating arm 111, the second radiating arm 112, the third radiating arm 121, and the fourth radiating arm 122 are the metal layers located on the dielectric substrate is used for description.

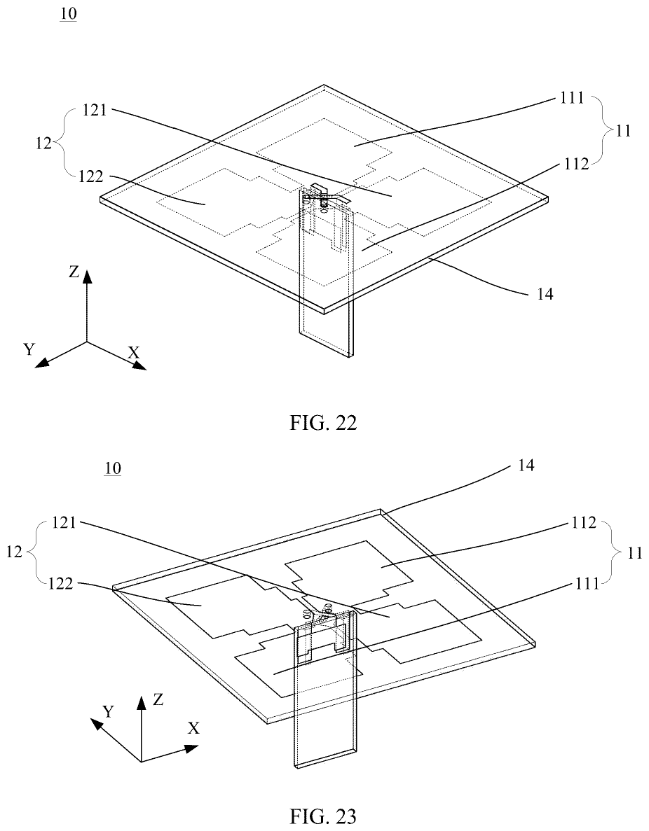

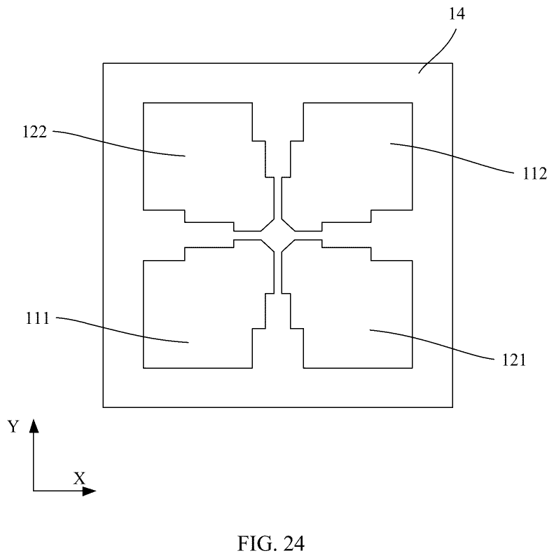

For example, as shown in FIG. 22 and FIG. 23, the first radiating arm 111, the second radiating arm 112, the third radiating arm 121, and the fourth radiating arm 122 are all copper layers on the dielectric substrate. The antenna 10 includes a first dielectric substrate 14. The first radiating arm 111, the second radiating arm 112, the third radiating arm 121, and the fourth radiating arm 122 are all copper layers on the first dielectric substrate 14, and are located on a same surface (for example, a lower surface in FIG. 23) of the first dielectric substrate 14. In addition, shapes of the first radiating arm 111, the second radiating arm 112, the third radiating arm 121, and the fourth radiating arm 122 may all be substantially rectangular. In addition, the first radiating arm 111, the second radiating arm 112, the third radiating arm 121, and the fourth radiating arm 122 may all be substantially in a step shape. For example, as shown in FIG. 24, the first radiating arm 111, the second radiating arm 112, the third radiating arm 121, and the fourth radiating arm 122 separately extend outward from a center in the step shape.

In summary, the first radiating arm 111 is adjacent to the third radiating arm 121 and the fourth radiating arm 122, and the second radiating arm 112 is adjacent to the third radiating arm 121 and the fourth radiating arm 122. The first radiating arm 111, the second radiating arm 112, the third radiating arm 121, and the fourth radiating arm 122 are all located on a substantially same plane.

In addition, a structure in the stepped shape can effectively improve isolation of the antenna 10. For example, as shown in FIG. 18 and FIG. 19, when the first radiating arm 111 and the third radiating arm 121 are fed, a current in the first radiating arm 111 and the third radiating arm 121 and a current in the second radiating arm 112 and the fourth radiating arm 122 are respectively in a V shape and an inverted V shape. With reference to FIG. 13 to FIG. 16, it can be obviously learned that the current distribution in FIG. 18 and FIG. 19 is orthogonal to the current distribution in FIG. 13 to FIG. 16. This achieves good isolation of the antenna 10, which can ensure signal transceiver performance of the antenna 10.

In summary, after the first radiating arm 111, the second radiating arm 112, the third radiating arm 121, and the fourth radiating arm 122 are all disposed to be in the step shape, isolation of the antenna 10 can be effectively improved, and signal transceiver performance of the antenna 10 can be ensured.

In the examples provided in FIG. 22 to FIG. 24, shapes and sizes of all radiating arms are basically the same. In another example, the sizes of the radiating arms may be different.

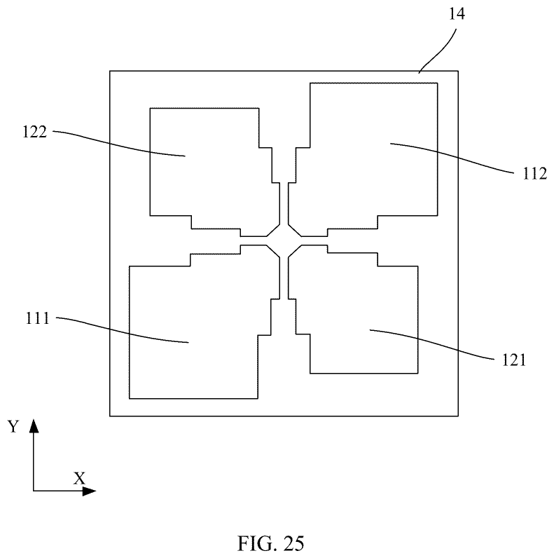

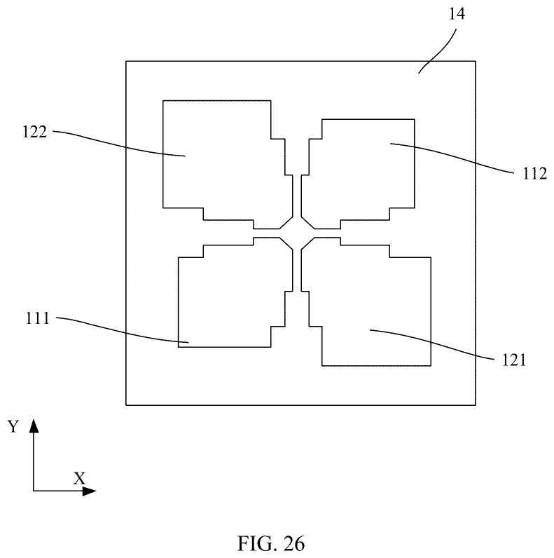

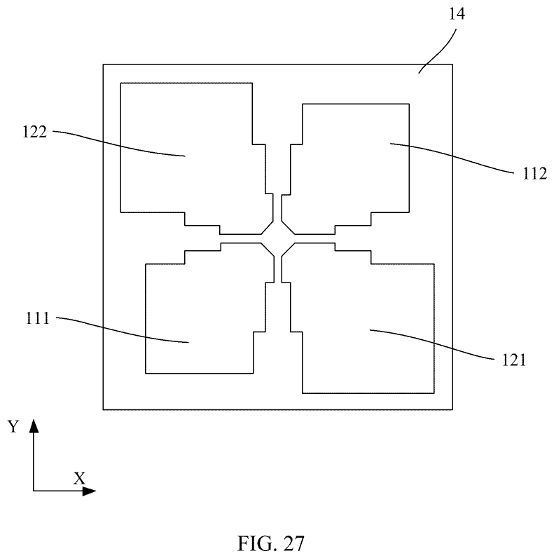

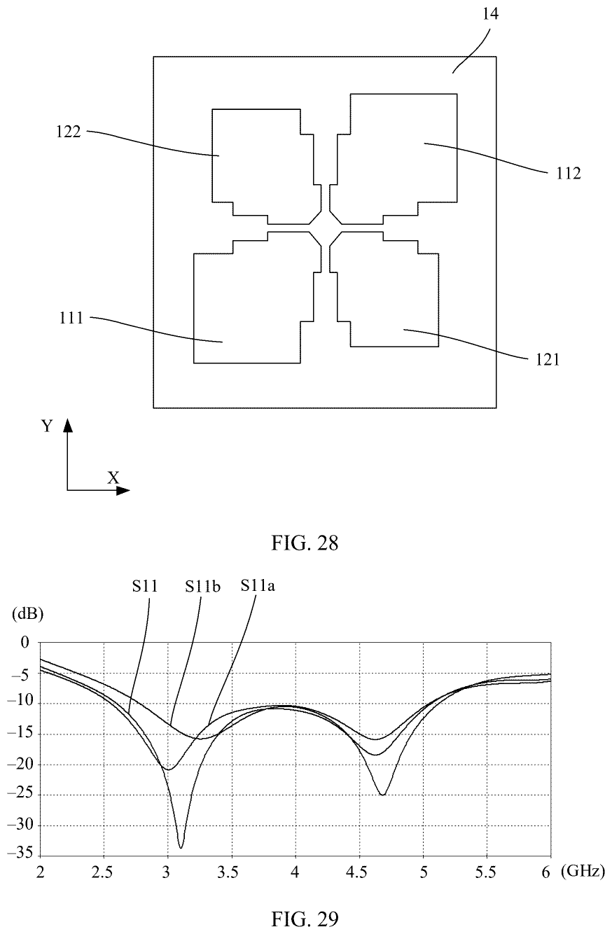

For example, as shown in FIG. 25, lengths of the first radiating arm 111 and the second radiating arm 112 are large, and lengths of the third radiating arm 121 and the fourth radiating arm 122 remain unchanged. Alternatively, as shown in FIG. 26, the lengths of the first radiating arm 111 and the second radiating arm 112 are small, and the lengths of the third radiating arm 121 and the fourth radiating arm 122 remain unchanged. Alternatively, as shown in FIG. 27, the lengths of the third radiating arm 121 and the fourth radiating arm 122 are large, and the lengths of the first radiating arm 111 and the second radiating arm 112 remain unchanged. Alternatively, as shown in FIG. 28, the lengths of the third radiating arm 121 and the fourth radiating arm 122 are small, and the lengths of the first radiating arm 111 and the second radiating arm 112 remain unchanged.

In addition, as shown in FIG. 29 to FIG. 32, S parameters of the antenna 10 in different sizes are shown.

In FIG. 29 to FIG. 32, a horizontal coordinate represents a frequency in a unit of GHz, and a vertical coordinate represents a return loss in a unit of dB.

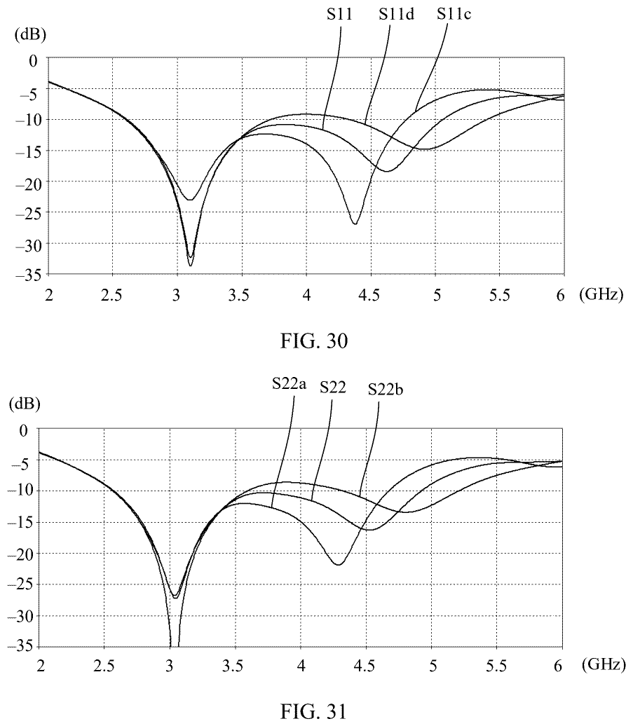

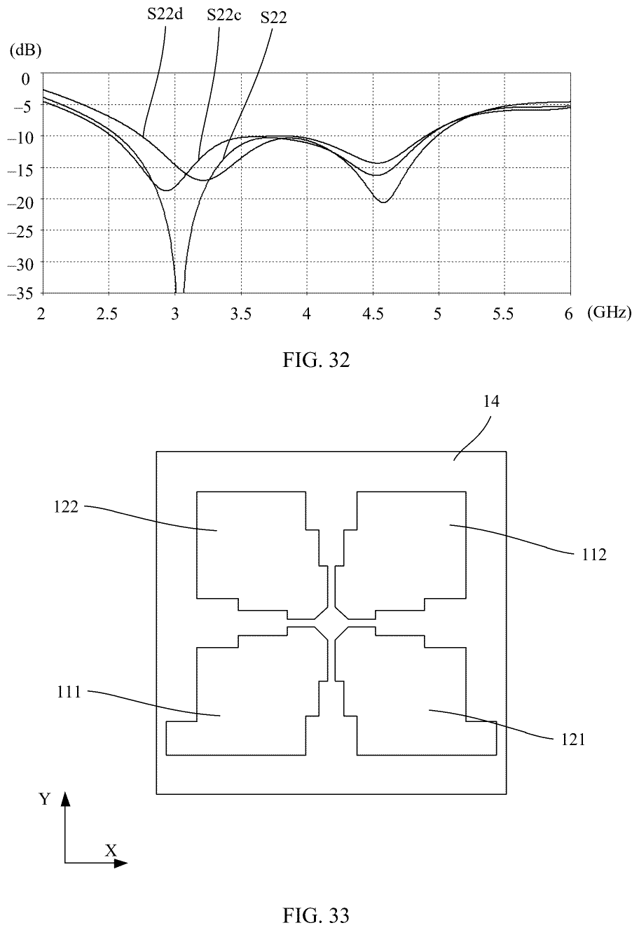

In both FIG. 29 and FIG. 30, S11 represents a curve of a return loss that is of the first polarized element shown in FIG. 24 and that changes with the frequency. In both FIG. 31 and FIG. 32, S22 represents a curve of a return loss that is of the second polarized element shown in FIG. 24 and that changes with the frequency.

In FIG. 29, S11a represents a curve of a return loss that is of the first polarized element shown in FIG. 25 and that changes with the frequency; and S11b represents a curve of a return loss that is of the first polarized element shown in FIG. 26 and that changes with the frequency.

In FIG. 30, S11c represents a curve of a return loss that is of the first polarized element shown in FIG. 27 and that changes with the frequency; and S11d represents a curve of a return loss that is of the first polarized element shown in FIG. 28 and that changes with the frequency.

In FIG. 31, S22a represents a curve of a return loss that is of the second polarized element shown in FIG. 25 and that changes with the frequency; and S22b represents a curve of a return loss that is of the first polarized element shown in FIG. 26 and that changes with the frequency.

In FIG. 32, S22c represents a curve of a return loss that is of the second polarized element shown in FIG. 27 and that changes with the frequency; and S22d represents a curve of a return loss that is of the first polarized element shown in FIG. 28 and that changes with the frequency.

It can be learned from FIG. 29 that when the lengths of the first radiating arm 111 and the second radiating arm 112 are changed, the first resonance of the first polarized element 11 shifts in frequency.

It can be learned from FIG. 30 that when the lengths of the third radiating arm 121 and the fourth radiating arm 122 are changed, the second resonance of the first polarized element 11 shifts in frequency.

It can be learned from FIG. 31 that when the lengths of the first radiating arm 111 and the second radiating arm 112 are changed, the second resonance of the second polarized element 12 shifts in frequency.

It can be learned from FIG. 32 that when the lengths of the third radiating arm 121 and the fourth radiating arm 122 are changed, the first resonance of the second polarized element 12 shifts in frequency.

A parameter analysis result is consistent with a current mode.

Alternatively, the sizes of the first radiating arm 111 and the second radiating arm 112 may be changed to properly adjust operating frequency bands of the first polarized element 11 and the second polarized element 12. The sizes of the third radiating arm 121 and the fourth radiating arm 122 may be changed to properly adjust the operating frequency bands of the second polarized element 12 and the first polarized element 11. In this way, the antenna 10 meets an application requirement.

In addition, the sizes of the first radiating arm 111 and the third radiating arm 121 may alternatively be adjusted to change an operating frequency band of the third polarized element.

For example, as shown in FIG. 33, in another example provided in this disclosure, length sizes of the first radiating arm 111 and the third radiating arm 121 are extended in both directions in which the first radiating arm 111 and the third radiating arm 121 are away from each other.

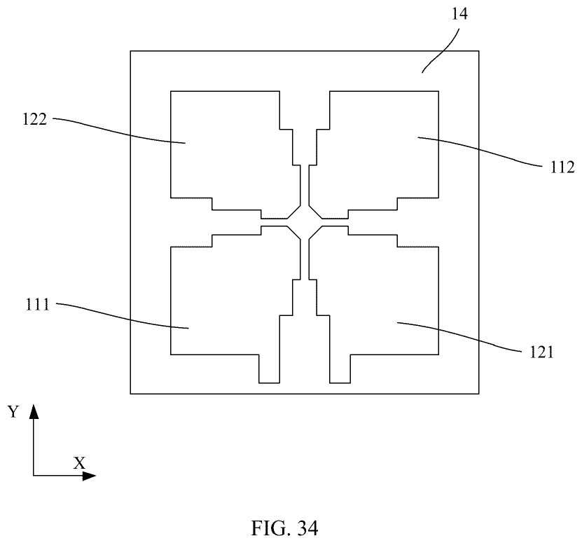

Alternatively, as shown in FIG. 34, in another example provided in this disclosure, the length size of the first radiating arm 111 is extended in a direction in which the first radiating arm 111 is away from the fourth radiating arm 122. The length size of the third radiating arm 121 is extended in a direction in which the third radiating arm 121 is away from the second radiating arm 112.

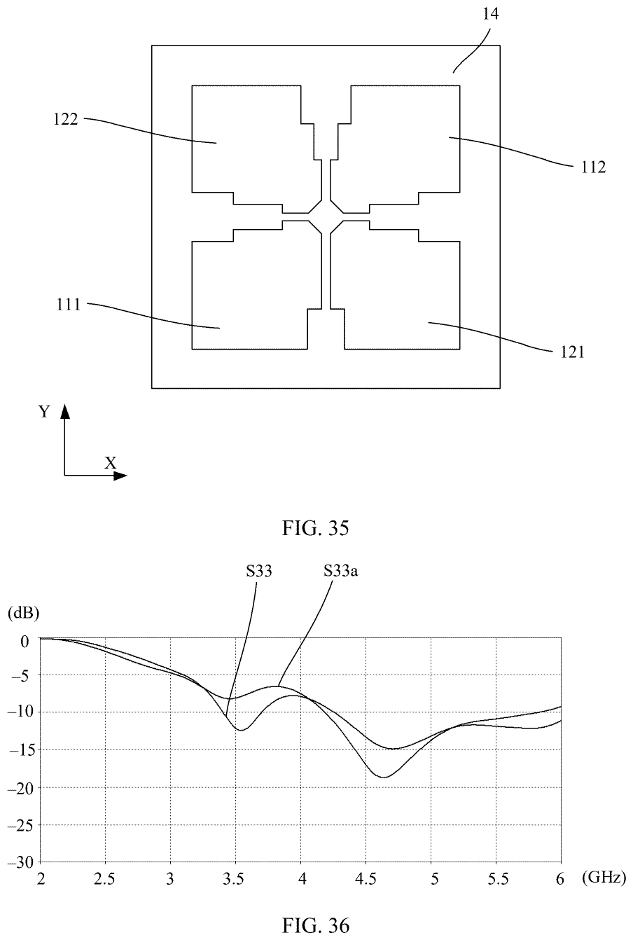

Alternatively, as shown in FIG. 35, in another example provided in this disclosure, the length size of the first radiating arm 111 is extended in both the direction in which the first radiating arm 111 faces the third radiating arm 121 and the direction in which the first radiating arm 111 is away from the fourth radiating arm 122. The length size of the third radiating arm 121 is extended in both a direction in which the third radiating arm 121 faces the first radiating arm 111 and the direction in which the third radiating arm 121 is away from the second radiating arm 112.

In addition, as shown in FIG. 36 to FIG. 38, S parameters of the antenna 10 in different sizes are shown.

In FIG. 36 to FIG. 38, a horizontal coordinate represents a frequency in a unit of GHz, and a vertical coordinate represents a return loss in a unit of dB.

In each of FIG. 36 to FIG. 38, S33 represents a curve of a return loss that is of the third polarized element and that changes with the frequency.

In FIG. 36, S33a represents a curve of a return loss that is of the third polarized element shown in FIG. 33 and that changes with the frequency.

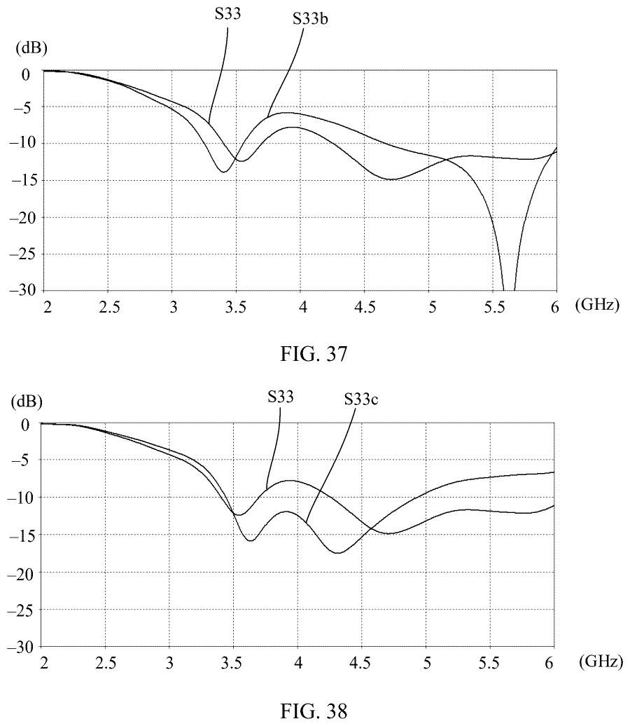

In FIG. 37, S33b represents a curve of a return loss that is of the third polarized element shown in FIG. 34 and that changes with the frequency.

In FIG. 38, S33c represents a curve of a return loss that is of the third polarized element shown in FIG. 35 and that changes with the frequency.

With reference to FIG. 36, FIG. 37, and FIG. 38, it can be learned that when the sizes of the first radiating arm 111 and the third radiating arm 121 are changed, two resonances of the third polarized element shift in frequency.

For example, based on S33 and S33a in FIG. 36, after the length sizes of the first radiating arm 111 and the third radiating arm 121 are extended in both directions in which the first radiating arm 111 and the third radiating arm 121 are away from each other, a current null in a first mode and a current null in a second mode are widened, that is, capacitive loading is implemented. There is a shift toward a low frequency in both the first mode and the second mode.

Based on S33 and S33b in FIG. 37, after the length size of the first radiating arm 111 is extended in the direction in which the first radiating arm 111 is away from the fourth radiating arm 122, and the length size of the third radiating arm 121 is extended in the direction in which the third radiating arm 121 is away from the second radiating arm 112, the current null in the first mode and a current maximum in the second mode are widened. Capacitive loading causes a downward frequency shift in the first mode, and inductive de-loading causes an upward frequency shift in the second mode.

Based on S33 and S33c in FIG. 38, after the length size of the first radiating arm 111 is extended in both the direction in which the first radiating arm 111 is away from the third radiating arm 121 and the direction in which the first radiating arm 111 is away from the fourth radiating arm 122, and the length size of the third radiating arm 121 is extended in both the direction in which the third radiating arm 121 is away from the first radiating arm 111 and the direction in which the third radiating arm 121 is away from the second radiating arm 112, a current maximum in a mode 1 and the current null in a mode 2 are widened. Inductive de-loading causes the upward frequency shift in the first mode, and capacitive loading causes the downward frequency shift in the second mode. A parameter analysis result is consistent with current distribution.

Alternatively, the sizes of the first radiating arm 111 and the third radiating arm 121 may be changed to properly adjust the operating frequency band of the antenna 10. In this way, the antenna 10 meets an application requirement.

The sizes of the first radiating arm 111, the second radiating arm 112, the third radiating arm 121, and the fourth radiating arm 122 may be properly adjusted based on an actual requirement. In this way, the antenna 10 meets an actual application requirement. Details are not described herein.

In addition, in the foregoing example, an example in which the third feed line circuit 133 is feed-connected to the first radiating arm 111 and the third radiating arm 121 is used for description. That is, the third polarized element includes the first radiating arm 111 and the third radiating arm 121. In another example, the third feed line circuit 133 may be alternatively feed-connected to the first radiating arm 111 and the fourth radiating arm 122. That is, the first radiating arm 111 and the fourth radiating arm 122 may form a new element. Alternatively, the third feed line circuit 133 may be feed-connected to the second radiating arm 112 and the third radiating arm 121. That is, the second radiating arm 112 and the third radiating arm 121 may form a new element. Alternatively, the third feed line circuit 133 may be feed-connected to the second radiating arm 112 and the fourth radiating arm 122. That is, the second radiating arm 112 and the fourth radiating arm 122 may form a new element.

It should be noted that for ease of understanding, the following provides description by using an example in which the third feed line circuit 133 is feed-connected to the second radiating arm 112 and the third radiating arm 121, and the element formed by the second radiating arm 112 and the third radiating arm 121 is referred to as the fourth polarized element.

In addition, this embodiment of this disclosure further provides a radiation pattern and S parameters of the antenna when the fourth polarized element includes the second radiating arm 112 and the third radiating arm 121.

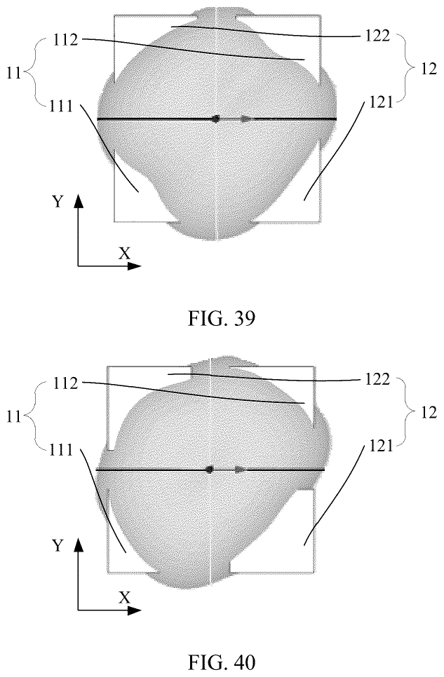

As shown in FIG. 39, when the antenna 10 operates at around 3.5 GHz, the fourth polarized element has obvious radiation gains in both the X-axis direction and the Y-axis direction. Therefore, lateral radiation of the antenna 10 can be implemented, and the signal coverage blind area of the antenna 10 can be effectively reduced.

As shown in FIG. 40, when the antenna 10 operates at around 4.5 GHz, the fourth polarized element has obvious radiation gains in both the X-axis direction and the Y-axis direction. Therefore, lateral radiation of the antenna 10 can be implemented, and the signal coverage blind area of the antenna 10 can be effectively reduced.

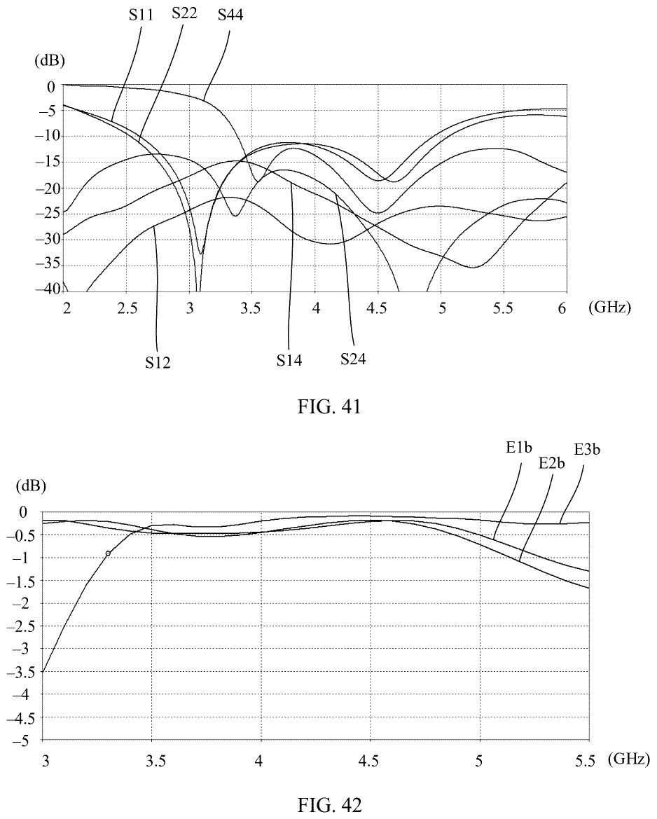

In addition, as shown in FIG. 41, in an example provided in this disclosure, S parameters of the antenna 10 are further provided when the first polarized element 11, the second polarized element 12, and the fourth polarized element are fed. In FIG. 41, a horizontal coordinate represents a frequency in a unit of GHz, and a vertical coordinate represents a return loss in a unit of dB. S11 represents a curve of a return loss that is of the first polarized element 11 and that changes with the frequency. S22 represents a curve of a return loss that is of the second polarized element 12 and that changes with the frequency. S44 represents a curve of a return loss that is of the fourth polarized element and that changes with the frequency. S12 represents isolation between the first polarized element 11 and the second polarized element 12. S14 represents isolation between the first polarized element 11 and the fourth polarized element. S24 represents isolation between the second polarized element 12 and the fourth polarized element.

It can be learned from FIG. 41 that the antenna 10 has two resonances: around 3.3 GHz and around 4.63 GHz, and may cover a frequency band from 3.3 GHz to 5 GHz. That is, the antenna 10 may completely cover frequency bands such as N77, N78, and N79. In addition, isolation between the first polarized element 11 and the second polarized element 12 is greater than 22 dB, isolation between the first polarized element 11 and the fourth polarized element is greater than 15 dB, and isolation between the second polarized element 12 and the fourth polarized element is greater than 17 dB. That is, good isolation is achieved among the first polarized element 11, the second polarized element 12, and the fourth polarized element, which can ensure signal transceiver performance of the antenna 10.

In addition, FIG. 42 further shows an efficiency simulation diagram of the antenna 10. In FIG. 42, a horizontal coordinate represents a frequency in a unit of GHz, and a vertical coordinate represents efficiency in a unit of dB. In FIG. 42, E1b represents efficiency of the first polarized element 11, E2b represents efficiency of the second polarized element 12, and E4b represents efficiency of the fourth polarized element.

In addition, with reference to FIG. 39 and FIG. 10, it can be learned that a radiation pattern shown in FIG. 39 is obtained after the radiation pattern shown in FIG. 10 is rotated by 90°. With reference to FIG. 40 and FIG. 11, it can be learned that a radiation pattern shown in FIG. 40 is obtained after the radiation pattern shown in FIG. 11 is rotated by 90°.

When the third feed line circuit 133 is feed-connected to the first radiating arm 111 and the third radiating arm 121, current distribution of the antenna 10 is that shown in FIG. 18 and FIG. 19. When the third feed line circuit 133 is feed-connected to the second radiating arm 112 and the third radiating arm 121, due to symmetry in a structure of the antenna 10, current distribution of the antenna 10 is obtained after rotation of 90° is performed on the current distribution shown in FIG. 18 and FIG. 19. That is, current distribution of the two feeding manners is not orthogonal. Therefore, when the two feeding manners coexist, good isolation cannot be achieved.

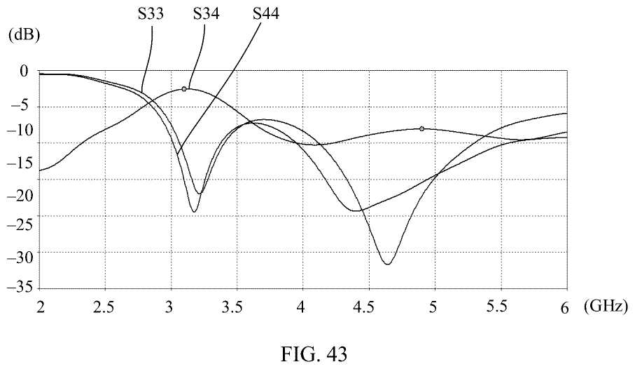

As shown in FIG. 43, when the foregoing two feeding manners coexist (that is, the third polarized element and the fourth polarized element coexist), isolation is poor. FIG. 43 shows S parameters of the antenna 10 when the foregoing two feeding manners coexist. In FIG. 43, a horizontal coordinate represents a frequency in a unit of GHz, and a vertical coordinate represents a return loss in a unit of dB. S33 represents a curve of a return loss that is of the third polarized element and that changes with the frequency. S44 represents a curve of a return loss that is of the fourth polarized element and that changes with the frequency. S34 represents isolation between the third polarized element and the fourth polarized element. It can be obviously learned from FIG. 43 that isolation between the third polarized element and the fourth polarized element is only about 2.5 dB and about 8 dB, and the isolation is very poor.

Therefore, either the third polarized element or the fourth polarized element may be disposed. Alternatively, the third polarized element and the fourth polarized element may not be fed at the same time, to ensure performance of the antenna 10.

In the foregoing example, an example in which the antenna 10 includes one element is used for description, that is, the element includes the first radiating arm 111, the second radiating arm 112, the third radiating arm 121, and the fourth radiating arm 122. However, in another example, the antenna 10 may also include two or more elements.

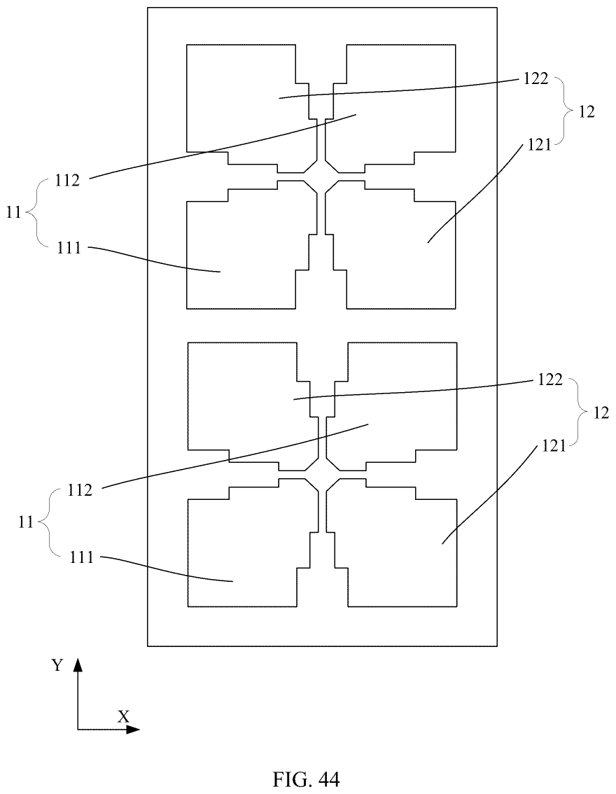

For example, as shown in FIG. 44, in another example provided in this disclosure, the antenna 10 includes two elements, and each element includes the first radiating arm 111, the second radiating arm 112, the third radiating arm 121, and the fourth radiating arm 122.

Two elements are disposed in the antenna 10, so that gains and signal transceiver performance of the antenna 10 can be improved.

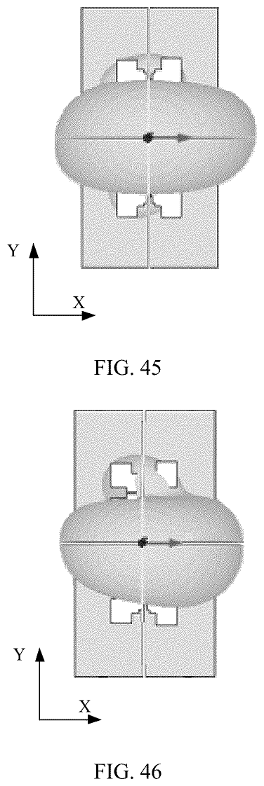

For example, when the antenna 10 operates at around 3.5 GHz, the first polarized elements 11 of the two elements are both fed. In this case, the radiation pattern of the antenna 10 is shown in FIG. 45.

When the antenna 10 operates at around 3.5 GHz, the second polarized elements 12 of the two elements are both fed. In this case, the radiation pattern of the antenna 10 is shown in FIG. 46.

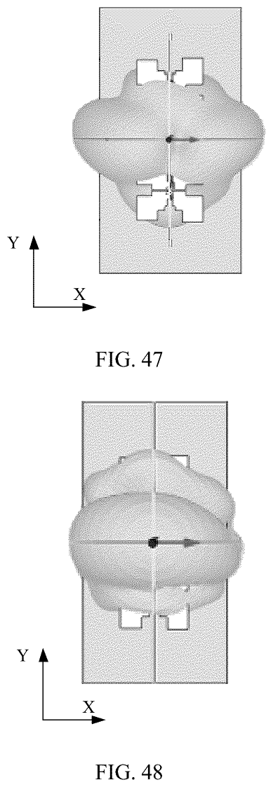

When the antenna 10 operates at around 3.5 GHz, the third polarized elements of the two elements are both fed. In this case, the radiation pattern of the antenna 10 is shown in FIG. 47.

When the antenna 10 operates at around 4.5 GHz, the first polarized elements 11 of the two elements are both fed. In this case, the radiation pattern of the antenna 10 is shown in FIG. 48.

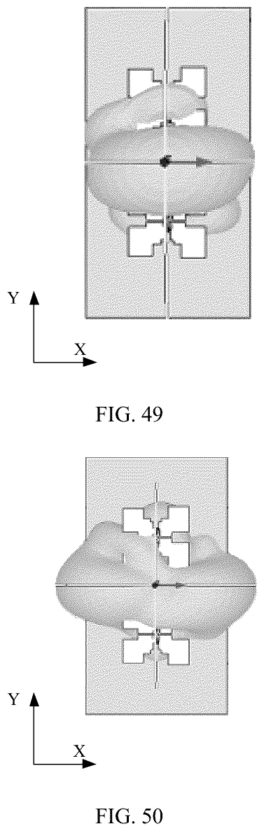

When the antenna 10 operates at around 4.5 GHz, the second polarized elements 12 of the two elements are both fed. In this case, the radiation pattern of the antenna 10 is shown in FIG. 49.

When the antenna 10 operates at around 4.5 GHz, the third polarized elements of the two elements are both fed. In this case, the radiation pattern of the antenna 10 is shown in FIG. 50.

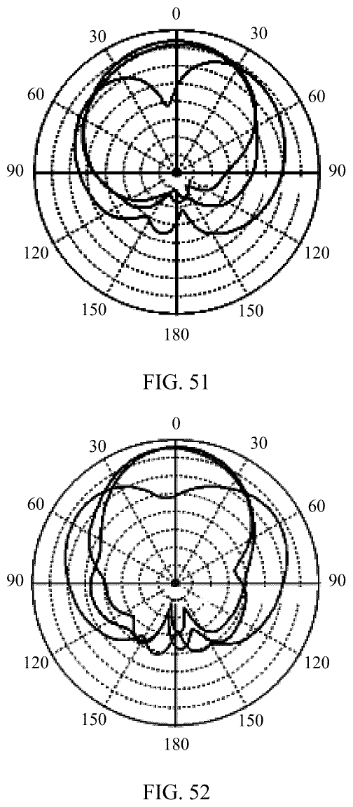

In addition, when the antenna 10 operates at around 3.5 GHz, the first polarized elements 11, the second polarized elements 12, and the third polarized elements of the two elements are all fed. In this case, the radiation pattern of the antenna 10 on a plane on which the X-axis and the Z-axis are located is shown in FIG. 51. When the antenna 10 operates at around 4.5 GHz, the first polarized elements 11, the second polarized elements 12, and the third polarized elements of the two elements are all fed. In this case, the radiation pattern of the antenna 10 on a plane on which the X-axis and the Z-axis are located is shown in FIG. 52.

In summary, in a case in which the two elements operate together, beam strength of the antenna 10 on a plane on which the Y-axis and the Z-axis are located is reduced, and beam strength of the antenna 10 on the plane on which the X-axis and the Z-axis are located is enhanced. This further reduces coverage blind areas of the antenna 10 in lateral directions (the X-axis direction and the Z-axis direction).

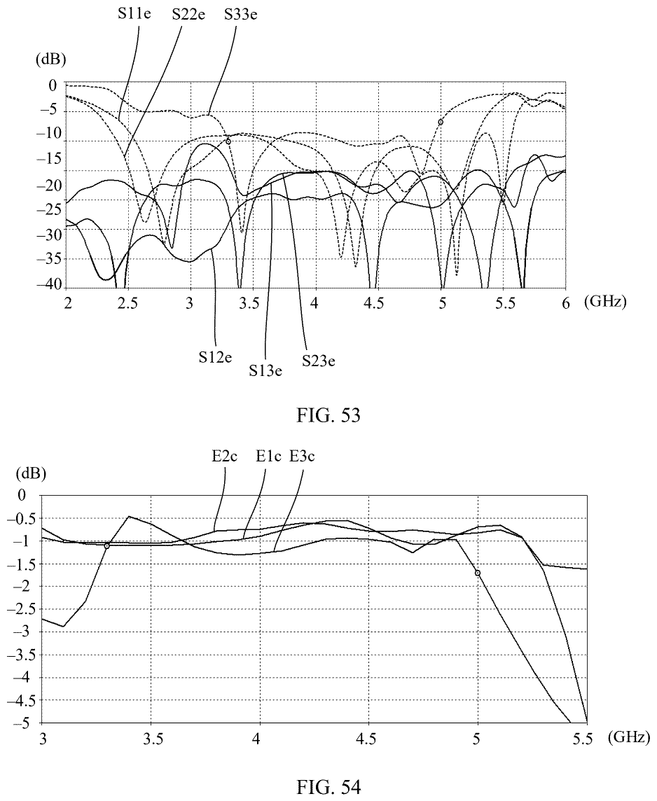

In addition, as shown in FIG. 53, in an example provided in this disclosure, S parameters of the antenna 10 are further provided when the first polarized element 11, the second polarized element 12, and the third polarized element that are of the antenna and that are shown in FIG. 44 are fed.

In FIG. 53, a horizontal coordinate represents a frequency in a unit of GHz, and a vertical coordinate represents a return loss in a unit of dB. S11e represents a curve of a return loss that is of the first polarized element 11 and that changes with the frequency. S22e represents a curve of a return loss that is of the second polarized element 12 and that changes with the frequency. S33e represents a curve of a return loss that is of the third polarized element and that changes with the frequency. S12e represents isolation between the first polarized element 11 and the second polarized element 12. S13e represents isolation between the first polarized element 11 and the third polarized element. S23e represents isolation between the second polarized element 12 and the third polarized element.

It can be learned from FIG. 53 that the antenna 10 may cover a frequency band from 3.3 GHz to 5 GHz. That is, the antenna 10 may completely cover frequency bands such as N 77, N78, and N79. In addition, isolation between the first polarized element 11 and the second polarized element 12 is greater than 20 dB, isolation between the first polarized element 11 and the third polarized element is greater than 15 dB, and isolation between the second polarized element 12 and the third polarized element is greater than 15 dB. That is, good isolation is achieved among the first polarized element 11, the second polarized element 12, and the third polarized element, which can ensure signal transceiver performance of the antenna 10.

In addition, FIG. 54 further shows an efficiency simulation diagram of the antenna 10. In FIG. 54, a horizontal coordinate represents a frequency in a unit of GHz, and a vertical coordinate represents efficiency in a unit of dB. In FIG. 54, E1c represents efficiency of the first polarized element 11, E2c represents efficiency of the second polarized element 12, and E3c represents efficiency of the third polarized element.

In the foregoing example, an example in which the antenna 10 includes two elements is used for description. In another example, the antenna 10 may also include three or more elements. In some embodiments, a quantity and position arrangement of elements included in the antenna 10 may be properly set based on an actual requirement. Details are not described herein.

Structure types of the first feed line circuit 131, the second feed line circuit 132, and the third feed line circuit 133 may be diverse.

For ease of understanding the technical solutions of this disclosure, the following first describes structures of the first feed line circuit 131 and the second feed line circuit 132.

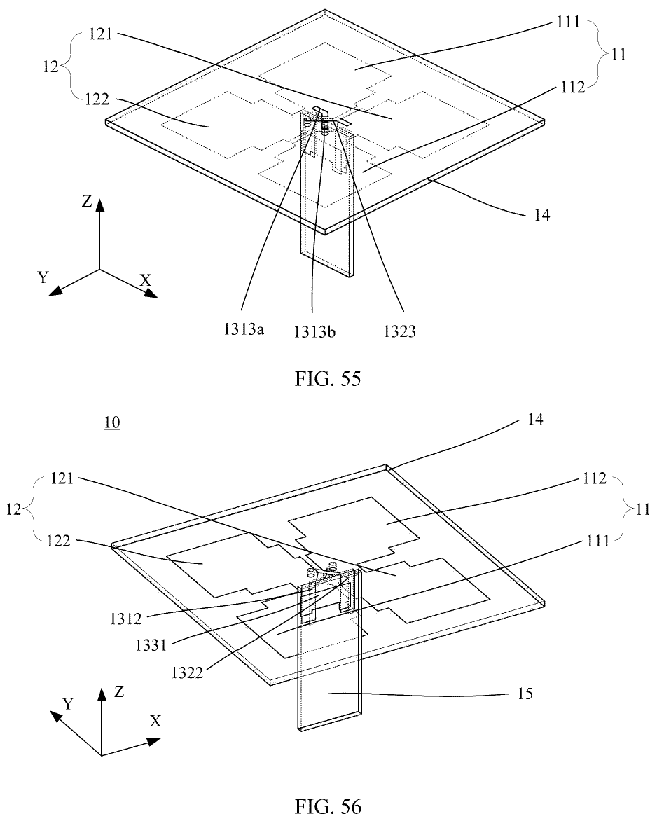

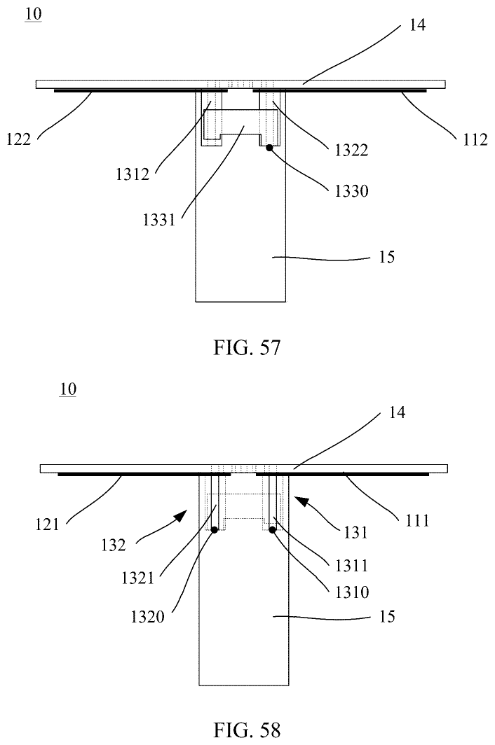

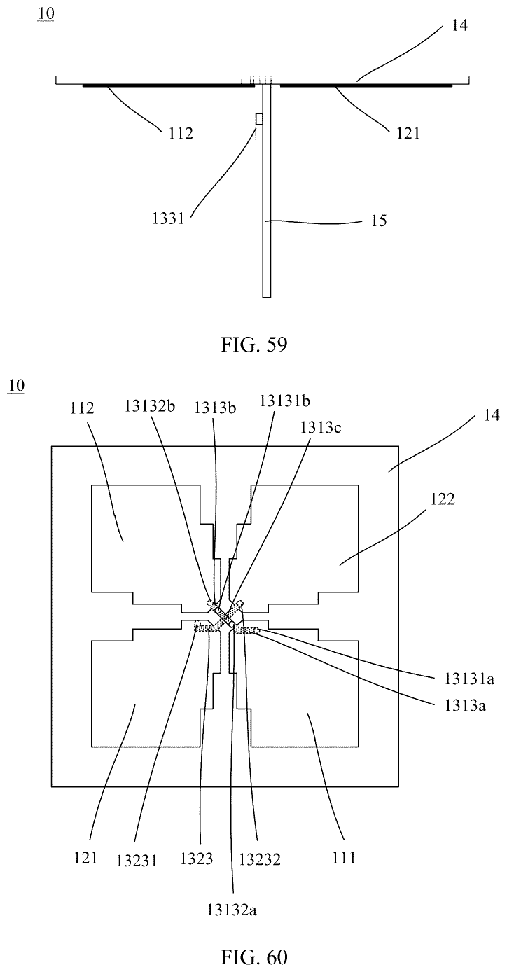

Refer to FIG. 55 to FIG. 60. FIG. 55 is a three-dimensional diagram of the antenna 10 from a top view angle. FIG. 56 is a three-dimensional diagram of the antenna 10 from a bottom view angle. FIG. 57 is a side view of the antenna 10. FIG. 58 is a side view of the antenna 10 from another perspective. FIG. 59 is a side view of the antenna 10 from another perspective. FIG. 60 is a plane diagram of the antenna 10 from a top view angle. In an example provided in this disclosure, the first feed line circuit 131 includes a first feed line 1311 and a first ground line 1312. The first ground line 1312 is feed-connected to the first radiating arm 111, and the first feed line 1311 is feed-connected to the second radiating arm 112. The second feed line circuit 132 includes a second feed line 1321 and a second ground line 1322. The second ground line 1322 is feed-connected to the third radiating arm 121, and the second feed line 1321 is feed-connected to the fourth radiating arm 122.

The antenna 10 may further include a second dielectric substrate 15. The second dielectric substrate 15 is located on a side of the first dielectric substrate 14, and the first dielectric substrate 14 and the second dielectric substrate 15 may be perpendicular to each other, or the first dielectric substrate 14 is disposed at an angle with the second dielectric substrate 15. Portions of the feed line circuits are located on the second dielectric substrate 15, and the other portions of the feed line circuits are located on the first dielectric substrate 14. The first dielectric substrate 14 and the second dielectric substrate 15 may be fastened in a manner such as bonding or clamping, or may be fastened in a manner such as welding. A manner of connecting the first dielectric substrate 14 and the second dielectric substrate 15 is not limited in this disclosure.

Both the first dielectric substrate 14 and the second dielectric substrate 15 may be dielectric substrates used to prepare a printed circuit board, or may be of other types of structures. Parameters such as types and shapes of the first dielectric substrate 14 and the second dielectric substrate 15 may be properly selected based on an actual requirement. Details are not described herein.

In an example provided in this disclosure, the first feed line 1311 and the first ground line 1312 form a microstrip transmission line, and the second feed line 1321 and the second ground line 1322 form a microstrip transmission line. Both the first feed line 1311 and the second feed line 1321 are located on a same substrate surface of the second dielectric substrate 15, and both the first ground line 1312 and the second ground line 1322 are located on the other substrate surface of the second dielectric substrate 15. In this way, a feed signal can be effectively radiated between the first feed line 1311 and the first ground line 1312, and the feed signal can be effectively radiated between the second feed line 1321 and the second ground line 1322.

The first radiating arm 111, the second radiating arm 112, the third radiating arm 121, and the fourth radiating arm 122 are all located on a lower substrate surface of the first dielectric substrate 14. One end of the first ground line 1312 extends to the lower substrate surface of the first dielectric substrate 14 and is connected to the first radiating arm 111. One end of the second ground line 1322 extends to the lower substrate surface of the first dielectric substrate 14 and is connected to the third radiating arm 121.

In addition, as shown in FIG. 55 and FIG. 60, one substrate surface (for example, an upper substrate surface in FIG. 55) of the first dielectric substrate 14 has a first connection line 1313a, a first connection line 1313b, and a second connection line 1323. Another substrate surface (for example, the lower substrate surface in FIG. 55) of the first dielectric substrate 14 has a first connection line 1313c (not shown in FIG. 55). As shown in FIG. 60, one end of the first connection line 1313a has a metallized via 13131a that penetrates a thickness of the first dielectric substrate 14, and the other end of the first connection line 1313a has a metallized via 13132a that penetrates the thickness of the first dielectric substrate 14. One end of the first connection line 1313b has a metallized via 13131b that penetrates the thickness of the first dielectric substrate 14, and the other end of the first connection line 1313b has a metallized via 13132b that penetrates the thickness of the first dielectric substrate 14. One end of the second connection line 1323 has a metallized via 13231 that penetrates the thickness of the first dielectric substrate 14, and the other end of the second connection line 1323 has a metallized via 13232 that penetrates the thickness of the first dielectric substrate 14.

The first feed line 1311 is connected to one end of the first connection line 1313a through the metallized via 13131a, the other end of the first connection line 1313a is connected to one end of the first connection line 1313c through the metallized via 13132a, the other end of the first connection line 1313c is connected to the first connection line 1313b through the metallized via 13131b, and the other end of the first connection line 1313b is connected to the second radiating arm 112 through the metallized via 13132b. That is, the first feed line 1311, the metallized via 13131a, the first connection line 1313a, the metallized via 13132a, the first connection line 1313c, the metallized via 13131b, the first connection line 1313b, and the metallized via 13132b form a feed path connected to the second radiating arm 112.

The second feed line 1321 is connected to one end of the second connection line 1323 through the metallized via 13231, and the other end of the second connection line 1323 is connected to the fourth radiating arm 122 through the metallized via 13232. That is, the second feed line 1321, the metallized via 13231, the second connection line 1323, and the metallized via 13232 form a feed path connected to the fourth radiating arm 122.

1310 in FIG. 58 is a feed point of the first feed line circuit 131, and is configured to connect to the radio frequency processing unit.

Refer to FIG. 57, FIG. 58, and FIG. 60. When the first polarized element 11 is fed, a current flows from the first ground line 1312 to the first radiating arm 111. The current flows from the first feed line 1311, the metallized via 13131a, the first connection line 1313a, the metallized via 13132a, the first connection line 1313c, the metallized via 13131b, the first connection line 1313b, and the metallized via 13132b to the second radiating arm 112. In this way, the first polarized element 11 radiates an electromagnetic wave.

1320 in FIG. 58 is a feed point of the second feed line circuit 132, and is configured to connect to the radio frequency processing unit. When the second polarized element 12 is fed, the current flows from the second ground line 1322 to the third radiating arm 121. The current flows from the second feed line 1321, the metallized via 13231, the second connection line 1323, and the metallized via 13232 to the fourth radiating arm 122. In this way, the second polarized element 12 radiates an electromagnetic wave.

The first connection line 1313a, the first connection line 1313b, the first connection line 1313c, and the second connection line 1323 may be metal wires or the like. Currently commonly used types may be selected for the first connection line 1313a, the first connection line 1313b, the first connection line 1313c, and the second connection line 1323. Details are not described in this disclosure.

For the third feed line circuit, in an example provided in this disclosure, portions of the first feed line circuit 131 and the second feed line circuit 132 are reused.

The third feed line circuit may be feed-connected to the first radiating arm 111 and the third radiating arm 121. Alternatively, the third feed line circuit may be feed-connected to the first radiating arm 111 and the fourth radiating arm 122. Alternatively, the third feed line circuit may be feed-connected to the second radiating arm 112 and the third radiating arm 121. Alternatively, the third feed line circuit may be feed-connected to the second radiating arm 112 and the fourth radiating arm 122.

For ease of description, in the following examples, a structure of the third feed line circuit is described by using an example in which the third feed line circuit is feed-connected to the first radiating arm 111 and the third radiating arm 121, and the third feed line circuit is feed-connected to the second radiating arm 112 and the third radiating arm 121.

As shown in FIG. 55 to FIG. 60, the third feed line circuit is feed-connected to the first radiating arm 111 and the third radiating arm 121.

The third feed line circuit includes the first ground line 1312 and the second ground line 1322. In addition, the third feed line circuit further includes a first coupling piece. The first coupling piece 1331 is disposed on the second dielectric substrate 15, and maintains a distance from a surface of the second dielectric substrate 15 by using a support member (not marked in the figure). In addition, one end (for example, a right end in FIG. 57) of the first coupling piece 1331 is located on a side of the second ground line 1322, and the other end (for example, a left end in FIG. 57) of the first coupling piece 1331 is coupled to the first ground line 1312.

1330 in FIG. 57 is a feed point of the third feed line circuit, and is configured to connect to the radio frequency processing unit. When the third polarized element is fed, the current flows from the second ground line 1322 to the third radiating arm 121. The current is coupled from the first coupling piece 1331 to the first ground line 1312, and then flows from the first ground line 1312 to the first radiating arm 111. In this way, the third polarized element radiates an electromagnetic wave.

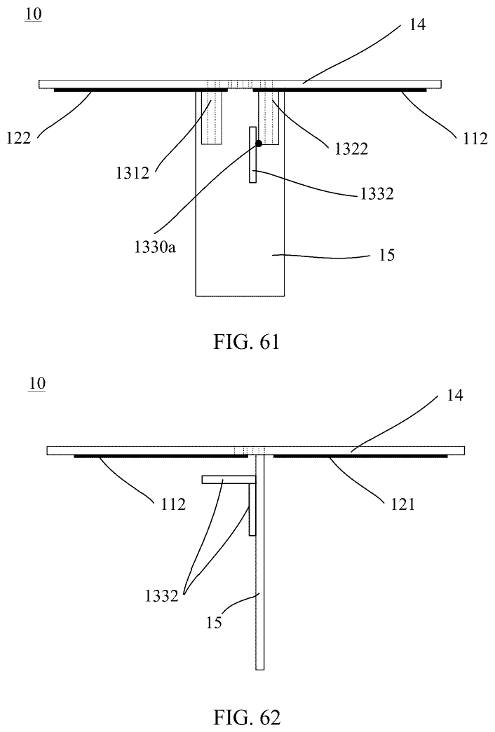

Alternatively, as shown in FIG. 61 and FIG. 62, in another example provided in this disclosure, the third feed line circuit is feed-connected to the second radiating arm 112 and the third radiating arm 121. The element formed by the second radiating arm 112 and the third radiating arm 121 is referred to as the fourth element below.

The third feed line circuit includes the second ground line 1322. In addition, the third feed line circuit further includes a second coupling piece 1332. The second coupling piece 1332 is disposed on the second dielectric substrate 15, and maintains a distance from a surface of the second dielectric substrate 15 by using a support member (not marked in the figure). In addition, one end of the second coupling piece 1332 is located on a side of the second ground line 1322, and the other end of the second coupling piece 1332 extends to a lower side of the second radiating arm 112 and is coupled to the second radiating arm 112.

1330a in FIG. 61 is a feed point of the third feed line circuit, and is configured to connect to the radio frequency processing unit. When the fourth polarized element is fed, the current flows from the second ground line 1322 to the third radiating arm 121. The current is coupled from the second coupling piece 1332 to the second radiating arm 112. In this way, the fourth polarized element radiates an electromagnetic wave.

For structures of the first feed line circuit 131 and the second feed line circuit 132, refer to the descriptions in the foregoing examples. Details are not described herein again.

In addition, the foregoing is merely an example description of the first feed line circuit 131, the second feed line circuit 132, and the third feed line circuit. In another example, a structure of each feed line circuit may also be properly selected and adjusted based on an actual requirement. Details are not described herein.

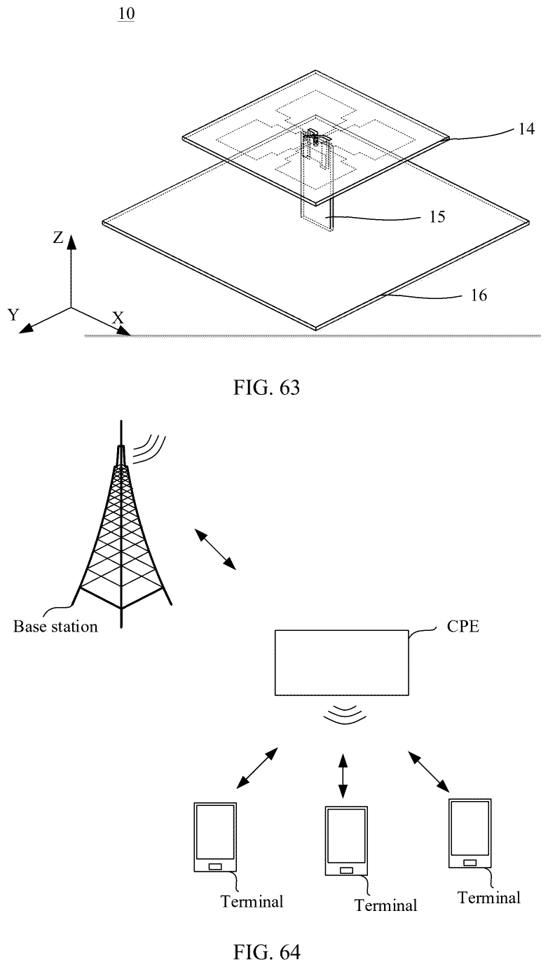

In addition, as shown in FIG. 63, in another example provided in this disclosure, the antenna 10 further includes a reflector plate 16. The reflector plate 16 and the first dielectric substrate 14 are disposed opposite to each other, and the second dielectric substrate 15 is connected between the first dielectric substrate 14 and the reflector plate 16. The reflector plate 16 may be a metal plate, or may be a printed circuit board, or the like. After an electromagnetic wave (e.g., an incident electromagnetic wave) propagates to a surface of the reflector plate 16, free electrons inside the reflector plate 16 are excited by the electromagnetic wave, and start to vibrate and accelerate. Movement of these free electrons in the reflector plate 16 causes generation of a current. Then, a reflected wave that has a same frequency as the incident electromagnetic wave but is opposite to the frequency of the incident electromagnetic wave is generated. This implements a reflection function of the reflector plate 16 on the electromagnetic wave. In some embodiments, a structure type of the reflector plate 16 may be properly selected based on an actual requirement. This is not limited in this disclosure. In addition, the reflector plate 16 may be fastened to the second dielectric substrate 15 in a manner such as bonding or clamping. This is not described herein again.

The feed network may further include a device such as a phase shifter, a combiner, a transmission or calibration network, or a filter. In some embodiments, a type and a quantity of devices included in the feed network may be properly selected based on an actual requirement. Details are not described herein.

The antenna 10 may be used in a communication device such as CPEs, a base station, a router, a base station, or a radar, to implement a wireless communication function.

For example, as shown in FIG. 64, in an example provided in this disclosure, a communication system is further provided, including a communication device and a terminal. The communication device includes a CPE and a base station. The CPE is communicatively connected to the base station, and the CPE is communicatively connected to the terminal. The terminal may be a terminal having a wireless communication function, such as a mobile phone, a tablet computer, or a notebook computer. A type of the terminal is not limited.

The base station may be located in a base station subsystem (BBS), a terrestrial radio access network (UTRAN), or an evolved universal terrestrial radio access network (E-UTRAN), and is configured to perform cell coverage of a radio signal, to implement communication between a terminal device and a wireless network. The base station may be a base transceiver station (BTS) in a global system for mobile communication (GSM) or a code division multiple access (CDMA) system, may be a NodeB (NB) in a wideband code division multiple access (WCDMA) system, may be an evolved NodeB (eNB, or eNodeB) in a long term evolution (LTE) system, or may be a radio controller in a cloud radio access network (CRAN) scenario. Alternatively, the base station may be a relay station, an access point, a vehicle-mounted device, a wearable device, a gNodeB (gNB) in a new radio (NR) system, a base station in a future evolved network, or the like. This is not limited in embodiments of this disclosure.

The antenna 10 may also be used in an access network device, and the access network device is sometimes referred to as an access node. The access network device has a wireless transceiver function, and is configured to communicate with a terminal. The access network device includes but is not limited to a base station in the foregoing communication system, an evolved NodeB (eNodeB), a transmission reception point (TRP), a next generation NodeB (gNB) in a 5G mobile communication system, a next generation base station in a future communication system, an access network device or a module of an access network device in an open access network ORAN (open RAN or ORAN) system, a base station in a future mobile communication system, an access node in a Wi-Fi system, or the like. Alternatively, the access network device may be a module or a unit that can implement some functions of the base station. For example, the access network device may be a central unit (CU), a distributed unit (DU), a CU-control plane (CP), a CU-user plane (UP), a radio unit (RU), or the like described below. In the ORAN system, the CU may also be referred to as an O-CU, the DU may also be referred to as an open (O)-DU, the CU-CP may also be referred to as an O-CU-CP, the CU-UP may also be referred to as an O-CUP-UP, and the RU may also be referred to as an O-RU. The access network device may be a macro base station, a micro base station, or an indoor base station, a relay node or a donor node, or a radio controller in a cloud radio access network (CRAN) scenario. Optionally, the access network device may alternatively be a server, a wearable device, a vehicle-mounted device, or the like. For example, an access network device in a vehicle to everything (V2X) technology may be a road side unit (RSU). A plurality of access network devices in the communication system may be base stations of a same type, or may be base stations of different types. The base station may communicate with a terminal, or may communicate with the terminal through a relay station. The terminal may communicate with a plurality of base stations in different access technologies.

In various embodiments of this disclosure, unless otherwise stated or there is a logic conflict, terms and/or descriptions in different embodiments are consistent and may be mutually referenced, and technical features in different embodiments may be combined into a new embodiment based on an internal logical relationship thereof.

“A plurality of” in this disclosure means two or more than two. “And/or” describes an association relationship between associated objects and indicates that three relationships may exist. For example, A and/or B may indicate the following three cases: Only A exists, both A and B exist, and only B exists, where A and B may be singular or plural.

Various numbers in embodiments of this disclosure are merely used for differentiation for ease of description, and are not used to limit the scope of embodiments of this disclosure. Sequence numbers of the foregoing processes do not mean an execution sequence, and the execution sequence of the processes should be determined based on functions and internal logic of the processes.

1. An antenna, comprising:
a first polarized element comprising a first radiating arm and a second radiating arm;
a second polarized element comprising a third radiating arm and a fourth radiating arm, wherein the first polarized element and the second polarized element are orthogonally disposed; and
a feed network comprising a first feed line circuit, a second feed line circuit, and a third feed line circuit, wherein
the first feed line circuit is feed-connected to the first radiating arm and the second radiating arm, and the second feed line circuit is feed-connected to the third radiating arm and the fourth radiating arm;
the third feed line circuit is feed-connected to one of the third radiating arm or the fourth radiating arm; and
the third feed line circuit is feed-connected to one of the first radiating arm or the second radiating arm.

2. The antenna according to claim 1, wherein the first radiating arm, the second radiating arm, the third radiating arm, and the fourth radiating arm are all located on a same plane; and
the first radiating arm is separately adjacent to the third radiating arm and the fourth radiating arm, and the second radiating arm is separately adjacent to the third radiating arm and the fourth radiating arm.

3. The antenna according to claim 1, wherein the first feed line circuit comprises a first feed line and a first ground line, the first ground line is feed-connected to the first radiating arm, and the first feed line is feed-connected to the second radiating arm; and
the second feed line circuit comprises a second feed line and a second ground line, the second ground line is feed-connected to the third radiating arm, and the second feed line is feed-connected to the fourth radiating arm.

4. The antenna according to claim 3, wherein the third feed line circuit is feed-connected to the first radiating arm and the third radiating arm, and the third feed line circuit comprises the first ground line and the second ground line.

5. The antenna according to claim 4, wherein the third feed line circuit further comprises a first coupling piece, one end of the first coupling piece is located on a side of the second ground line, and the other end of the first coupling piece is coupled to the first ground line.

6. The antenna according to claim 3, wherein the third feed line circuit is feed-connected to the second radiating arm and the third radiating arm, the third feed line circuit comprises the second ground line and a second coupling piece, one end of the second coupling piece is located on a side of the second ground line, and the other end of the second coupling piece is coupled to the second radiating arm.

7. The antenna according to claim 1, wherein the antenna further comprises a first dielectric substrate, and wherein the first radiating arm, the second radiating arm, the third radiating arm, and the fourth radiating arm are all located on a same substrate surface of the first dielectric substrate.

8. The antenna according to claim 7, wherein the antenna further comprises a second dielectric substrate, and the second dielectric substrate is located on a side of the first dielectric substrate; and
portions of the first feed line circuit, the second feed line circuit, and the third feed line circuit are located on the second dielectric substrate, and other portions of the first feed line circuit, the second feed line circuit, and the third feed line circuit are located on the first dielectric substrate.

9. The antenna according to claim 8, wherein the antenna further comprises a reflector plate, the reflector plate and the first dielectric substrate are disposed opposite to each other, the second dielectric substrate is connected between the first dielectric substrate and the reflector plate, and the reflector plate is configured to reflect an electromagnetic wave radiated by the first polarized element and the second polarized element.

10. The antenna according to claim 1, wherein the first radiating arm, the second radiating arm, the third radiating arm, and the fourth radiating arm are all in a step shape.

11. The antenna according to claim 1, wherein the antenna comprises a plurality of main elements, and each main element comprises the first polarized element and the second polarized element.

12. A communication device, comprising:
an antenna, comprising:
a first polarized element comprising a first radiating arm and a second radiating arm;
a second polarized element comprising a third radiating arm and a fourth radiating arm, wherein the first polarized element and the second polarized element are orthogonally disposed; and
a feed network comprising a first feed line circuit, a second feed line circuit, and a third feed line circuit, wherein
the first feed line circuit is feed-connected to the first radiating arm and the second radiating arm, and the second feed line circuit is feed-connected to the third radiating arm and the fourth radiating arm;
the third feed line circuit is feed-connected to one of the third radiating arm or the fourth radiating arm; and
the third feed line circuit is feed-connected to one of the first radiating arm or the second radiating arm; and
a radio frequency processing unit connected to the feed network.

13. The communication device according to claim 12, wherein the first radiating arm, the second radiating arm, the third radiating arm, and the fourth radiating arm are all located on a same plane; and
the first radiating arm is separately adjacent to the third radiating arm and the fourth radiating arm, and the second radiating arm is separately adjacent to the third radiating arm and the fourth radiating arm.

14. The communication device according to claim 12, wherein the first feed line circuit comprises a first feed line and a first ground line, the first ground line is feed-connected to the first radiating arm, and the first feed line is feed-connected to the second radiating arm; and
the second feed line circuit comprises a second feed line and a second ground line, the second ground line is feed-connected to the third radiating arm, and the second feed line is feed-connected to the fourth radiating arm.

15. The communication device according to claim 14, wherein the third feed line circuit is feed-connected to the first radiating arm and the third radiating arm, and the third feed line circuit comprises the first ground line and the second ground line.

16. The communication device according to claim 15, wherein the third feed line circuit further comprises a first coupling piece, one end of the first coupling piece is located on a side of the second ground line, and the other end of the first coupling piece is coupled to the first ground line.

17. The communication device according to claim 14, wherein the third feed line circuit is feed-connected to the second radiating arm and the third radiating arm, the third feed line circuit comprises the second ground line and a second coupling piece, one end of the second coupling piece is located on a side of the second ground line, and the other end of the second coupling piece is coupled to the second radiating arm.

18. The communication device according to claim 12, wherein the antenna further comprises a first dielectric substrate, and the first radiating arm, the second radiating arm, the third radiating arm, and the fourth radiating arm are all located on a same substrate surface of the first dielectric substrate,
and wherein the antenna further comprises a second dielectric substrate, and the second dielectric substrate is located on a side of the first dielectric substrate; and
portions of the first feed line circuit, the second feed line circuit, and the third feed line circuit are located on the second dielectric substrate, and other portions of the first feed line circuit, the second feed line circuit, and the third feed line circuit are located on the first dielectric substrate.

19. The communication device according to claim 18, wherein the antenna further comprises a reflector plate, the reflector plate and the first dielectric substrate are disposed opposite to each other, the second dielectric substrate is connected between the first dielectric substrate and the reflector plate, and the reflector plate is configured to reflect an electromagnetic wave radiated by the first polarized element and the second polarized element.

20. The communication device according to claim 12, wherein the first radiating arm, the second radiating arm, the third radiating arm, and the fourth radiating arm are all in a step shape.
